(19) United States
(12) Patent Application Publication
(10) Pub. No.: US 2024/0340884 A1
(43) Pub. Date: Oct. 10, 2024

(54) TECHNIQUES FOR RESOLVING SCHEDULING CONFLICTS BETWEEN MEASUREMENT OR REPORTING OCCASIONS AND COMMUNICATIONS WITH ENERGY HARVESTING (EH)-CAPABLE DEVICES

(71) Applicant: QUALCOMM Incorporated, San Diego, CA (US)

(72) Inventors: Ahmed Elshafie, San Diego, CA (US); Huilin Xu, Temecula, CA (US); Linhai He, San Diego, CA (US)

(21) Appl. No.: 18/298,269

(22) Filed: Apr. 10, 2023

(51) Int. Cl. H04W 72/121; H04W 72/23

(52) U.S. Cl. CPC H04W 72/121; H04W 72/23

(57) ABSTRACT

Methods, systems, and devices for wireless communications are described. A user equipment (UE) may receive control signaling from a network entity to schedule two occasions. A first occasion may be for measurement or reporting, such as radio resource management (RRM) measurement or reporting, and a second occasion may be for communication with an energy harvesting (EH)-capable device. The UE may identify a conflict resolution scheme for resolving a scheduling conflict between the first occasion and the second occasion. The UE may communicate in accordance with the conflict resolution scheme.

### TECHNICAL FIELD

The following relates generally to wireless communications, and more specifically to techniques for resolving scheduling conflicts between measurement or reporting occasions and communications with energy harvesting (EH)-capable devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A UE may support communications with passive devices, such as passive Internet of Things (IoT) devices, among others. In some cases, the UE may be scheduled for communications with a passive device that conflict with communications scheduled with another communication device, such as a network entity.

### SUMMARY

The described techniques relate to improved methods, systems, devices, and apparatuses that support techniques for resolving scheduling conflicts between measurement or reporting occasions and communications with energy harvesting (EH)-capable devices. For example, a user equipment (UE) may support communicating with EH-capable devices, such as passive Internet of Things (IoT) devices, ambient IoT (A-IoT) devices, and radio frequency identification (RFID) tags, among others. In some cases, an occasion for communicating with an EH-capable device may conflict with (e.g., at least partially overlap with, occur within a threshold time gap of) an occasion for performing a management operation, such as a radio resource management (RRM) operation (e.g., an RRM measurement, reporting of an RRM measurement, a radio link monitoring (RLM) operation). In some examples, the UE may be unable to both communicate with the EH-capable device and perform the radio management operation due to the conflict.

The UE may be configured with a conflict resolution scheme for resolving a scheduling conflict between the EH-communication occasion and the radio management occasion. For example, the conflict resolution scheme may indicate whether the UE is to communicate with the EH-capable device or perform the radio management operation based on various criteria, such as respective priorities or quality of service (QoS) associated with the occasions, remaining packet delay for communicating with the EH-capable device, a quality of prior measurements, respective repetition factors associated with the occasions, or indication signaling from a network entity or by the UE, among others described herein. The UE may communicate in accordance with the conflict resolution scheme, such as by performing the management operation (e.g., performing and/or reporting the RRM measurement) or communicating with the EH-capable device.

A method for wireless communications at a UE is described. The method may include receiving, from a network entity, control signaling indicating that a first occasion is scheduled for an RRM operation and that a second occasion is scheduled for communication with an EH-capable device, identifying a conflict resolution scheme for resolving a scheduling conflict between the first occasion and the second occasion based on the first occasion at least partially overlapping with the second occasion or a time gap between the first occasion and the second occasion failing to satisfy a threshold time gap, and communicating, in accordance with the conflict resolution scheme, one of a signal with the EH-capable device during the second occasion or a report associated with the RRM operation.

An apparatus for wireless communications at a UE is described. The apparatus may include at least one processor, memory coupled (e.g., operatively, communicatively, functionally, electronically, or electrically) with the processor, and instructions stored in the memory. The instructions may be executable by the at least one processor (e.g., directly, indirectly, after pre-processing, without pre-processing) to cause the apparatus to receive, from a network entity, control signaling indicating that a first occasion is scheduled for an RRM operation and that a second occasion is scheduled for communication with an EH-capable device, identify a conflict resolution scheme for resolving a scheduling conflict between the first occasion and the second occasion based on the first occasion at least partially overlapping with the second occasion or a time gap between the first occasion and the second occasion failing to satisfy a threshold time gap, and communicating, in accordance with the conflict resolution scheme, one of a signal with the EH-capable device during the second occasion or a report associated with the RRM operation.

Another apparatus for wireless communications at a UE is described. The apparatus may include means for receiving, from a network entity, control signaling indicating that a first occasion is scheduled for an RRM operation and that a second occasion is scheduled for communication with an EH-capable device, means for identifying a conflict resolution scheme for resolving a scheduling conflict between the first occasion and the second occasion based on the first occasion at least partially overlapping with the second occasion or a time gap between the first occasion and the second occasion failing to satisfy a threshold time gap, and means for communicating, in accordance with the conflict resolution scheme, one of a signal with the EH-capable device during the second occasion or a report associated with the RRM operation.

A non-transitory computer-readable medium storing code for wireless communications at a UE is described. The code may include instructions executable by a processor (e.g., directly, indirectly, after pre-processing, without pre-processing) to receive, from a network entity, control signaling indicating that a first occasion is scheduled for an RRM operation and that a second occasion is scheduled for communication with an EH-capable device, identify a conflict resolution scheme for resolving a scheduling conflict between the first occasion and the second occasion based on the first occasion at least partially overlapping with the second occasion or a time gap between the first occasion and the second occasion failing to satisfy a threshold time gap, and communicating, in accordance with the conflict resolution scheme, one of a signal with the EH-capable device during the second occasion or a report associated with the RRM operation.

In some examples of the method, apparatuses, and non-transitory computer-readable medium described herein, the communicating may include operations, features, means, or instructions for communicating, in accordance with the conflict resolution scheme, the signal based on a first priority associated with a communication session with the EH-capable device being higher than a second priority of the RRM operation.

In some examples of the method, apparatuses, and non-transitory computer-readable medium described herein, the communicating may include operations, features, means, or instructions for communicating, in accordance with the conflict resolution scheme, the signal based on a quality of service associated with a communication session with the EH-capable device.

In some examples of the method, apparatuses, and non-transitory computer-readable medium described herein, the communicating may include operations, features, means, or instructions for communicating, in accordance with the conflict resolution scheme, the signal based on a remaining packet delay associated with a communication session with the EH-capable device.

In some examples of the method, apparatuses, and non-transitory computer-readable medium described herein, the communicating may include operations, features, means, or instructions for communicating, in accordance with the conflict resolution scheme, the signal based on a prior RRM operation satisfying a threshold.

In some examples of the method, apparatuses, and non-transitory computer-readable medium described herein, the communicating may include operations, features, means, or instructions for communicating, in accordance with the conflict resolution scheme, the report based on a prior RRM operation failing to satisfy a threshold.

In some examples of the method, apparatuses, and non-transitory computer-readable medium described herein, the communicating may include operations, features, means, or instructions for communicating, in accordance with the conflict resolution scheme, one of the report or the signal based on one or more previous conflict resolutions.

In some examples of the method, apparatuses, and non-transitory computer-readable medium described herein, identifying the conflict resolution scheme may include operations, features, means, or instructions for receiving, from the network entity, second control signaling indicating to communicate the report to the network entity or the signal with the EH-capable device during the second occasion, where one of the report or the signal may be communicated in accordance with the second control signaling.

In some examples of the method, apparatuses, and non-transitory computer-readable medium described herein, the communicating may include operations, features, means, or instructions for communicating, in accordance with the conflict resolution scheme, the report based on one or more repetitions being scheduled for communicating the signal with the EH-capable device.

In some examples of the method, apparatuses, and non-transitory computer-readable medium described herein, the communicating may include operations, features, means, or instructions for communicating, in accordance with the conflict resolution scheme, the report based on a radio link failure (RLF) for the UE or a cell change for the UE.

Some examples of the method, apparatuses, and non-transitory computer-readable medium described herein may further include operations, features, means, or instructions for transmitting, to the network entity, second control signaling indicating the UE will not perform the RRM operation at the first occasion, where the signal may be communicated based on the second control signaling.

Some examples of the method, apparatuses, and non-transitory computer-readable medium described herein may further include operations, features, means, or instructions for transmitting, to a second UE and to the network entity, second control signaling indicating the UE will not perform the communication with the EH-capable device at the second occasion, where the report may be communicated based on the second control signaling.

In some examples of the method, apparatuses, and non-transitory computer-readable medium described herein, the communicating may include operations, features, means, or instructions for communicating, in accordance with the conflict resolution scheme, the signal based on one or more repetitions being scheduled for the RRM operation.

In some examples of the method, apparatuses, and non-transitory computer-readable medium described herein, the communicating may include operations, features, means, or instructions for communicating, in accordance with the conflict resolution scheme, the report based on a first priority of the RRM operation being higher than a second priority of the communication with the EH-capable device.

In some examples of the method, apparatuses, and non-transitory computer-readable medium described herein, the threshold time gap may be based on which of the first occasion and the second occasion occurs first.

In some examples of the method, apparatuses, and non-transitory computer-readable medium described herein, the report may include an RRM measurement performed during the first occasion or may be communicated during the first occasion and include an RRM measurement performed during a third occasion before the first occasion.

### BRIEF DESCRIPTION OF THE DRAWINGS

FIGS. 1 and 2 show examples of wireless communications systems that support techniques for resolving scheduling conflicts between measurement or reporting occasions and communications with energy harvesting (EH)-capable devices in accordance with one or more aspects of the present disclosure.

FIGS. 3, 4, 5, and 6 show examples of a timing diagrams that support techniques for resolving scheduling conflicts between measurement occasions or reporting and communications with EH-capable devices in accordance with one or more aspects of the present disclosure.

FIG. 7 shows an example of a process flow that supports techniques for resolving scheduling conflicts between measurement occasions or reporting and communications with EH-capable devices in accordance with one or more aspects of the present disclosure.

FIGS. 8 and 9 show block diagrams of devices that support techniques for resolving scheduling conflicts between measurement occasions or reporting and communications with EH-capable devices in accordance with one or more aspects of the present disclosure.

FIG. 10 shows a block diagram of a communications manager that supports techniques for resolving scheduling conflicts between measurement occasions or reporting and communications with EH-capable devices in accordance with one or more aspects of the present disclosure.

FIG. 11 shows a diagram of a system including a device that supports techniques for resolving scheduling conflicts between measurement occasions or reporting and communications with EH-capable devices in accordance with one or more aspects of the present disclosure.

FIGS. 12 through 15 show flowcharts illustrating methods that support techniques for resolving scheduling conflicts between measurement occasions or reporting and communications with EH-capable devices in accordance with one or more aspects of the present disclosure.

### DETAILED DESCRIPTION

Some wireless communications systems may include passive devices, such as passive Internet of Things (IoT) devices, ambient-IoT (A-IoT) devices or radio frequency identifier (RFID) tags, among others, to perform operations such as location tracking and identification. Passive devices may receive power from transmissions by other devices, and thus may be referred to as energy harvesting (EH)-capable devices. For example, an interrogating device may transmit a continuous wave (CW) signal to the EH-capable device, and the EH-capable device may use energy from the CW signal to activate radio frequency components and communicate with the interrogating device or another device, such as by “backscattering” the CW signal. In some cases, EH-based communication processing may involve bi-static communications that include the EH-capable device and multiple network nodes such as a source network node (e.g., an interrogating device such as a user equipment (UE)) and a reader network node (e.g., a reader device such as another UE that receives the backscatter response). The source network node may transmit an interrogating signal to the EH-capable device for the EH-capable device to backscatter the signal. The reader network node may receive and decode the backscatter response to the signal. In some examples, the source network node and the reader network node may be a same network node.

In some cases, EH-based communication processing (e.g., A-IoT processing) may conflict with another operation performed by a network node. For example, a UE operating as a source network node or a reader network node may be scheduled with a first occasion to perform a radio management operation, such as a radio resource management (RRM) operation (e.g., an RRM measurement, reporting of an RRM measurement, a radio link monitoring (RLM) operation). In some cases, the first occasion may conflict with (e.g., at least partially overlap with, occur within a threshold time gap of) a second occasion with which the UE is scheduled to communicate with an EH-capable device. Due to the conflict, the UE may be unable to perform both the radio management operation and the communication with the EH-capable device. However, which operation to perform, the radio management operation of the communication with the EH-capable device, may be unclear.

In accordance with examples described herein, the UE may resolve the conflict between the first occasion for the radio management operation and the second occasion for the communication with the EH-capable device in accordance with a conflict resolution scheme. For example, when the UE is configured with conflicting EH-based communication processing (e.g., A-IoT processing) and radio management measurement or reporting, the UE may determine whether to perform the EH-based communication processing or the radio management operation in accordance with the conflict resolution scheme. The conflict resolution scheme may indicate one or more criteria for resolving the conflict (e.g., for determining which operation to perform), such as respective priorities or quality of service (QOS) associated with the occasions, remaining packet delay for communicating with the EH-capable device, a quality of prior measurements, respective repetition factors associated with the occasions, previously resolved conflicts, or indication signaling from a network entity or by the UE, among others described herein. Thus, implementation of the conflict resolution scheme may enable the UE to resolve the conflict and either perform the radio management operation during the first occasion or communicate with the EH-capable device during the second occasion.

By communicating in accordance with the conflict resolution scheme, ambiguity associated with conflicts between EH-based communication processing and radio management operations may be resolved. Additionally, the conflict resolution scheme may support the (e.g., dynamic, situationally-based) prioritization of EH-based communication processing or radio management operations, which may support increased data rates, capacity, and spectral efficiency, more efficient utilization of communication resources, and improved coordination between devices, among other benefits.

Aspects of the disclosure are initially described in the context of wireless communications systems. Aspects of the disclosure are additionally described in the context of timing diagrams and a process flow. Aspects of the disclosure are further illustrated by and described with reference to apparatus diagrams, system diagrams, and flowcharts that relate to techniques for resolving scheduling conflicts between measurement occasions or reporting and communications with EH-capable devices.

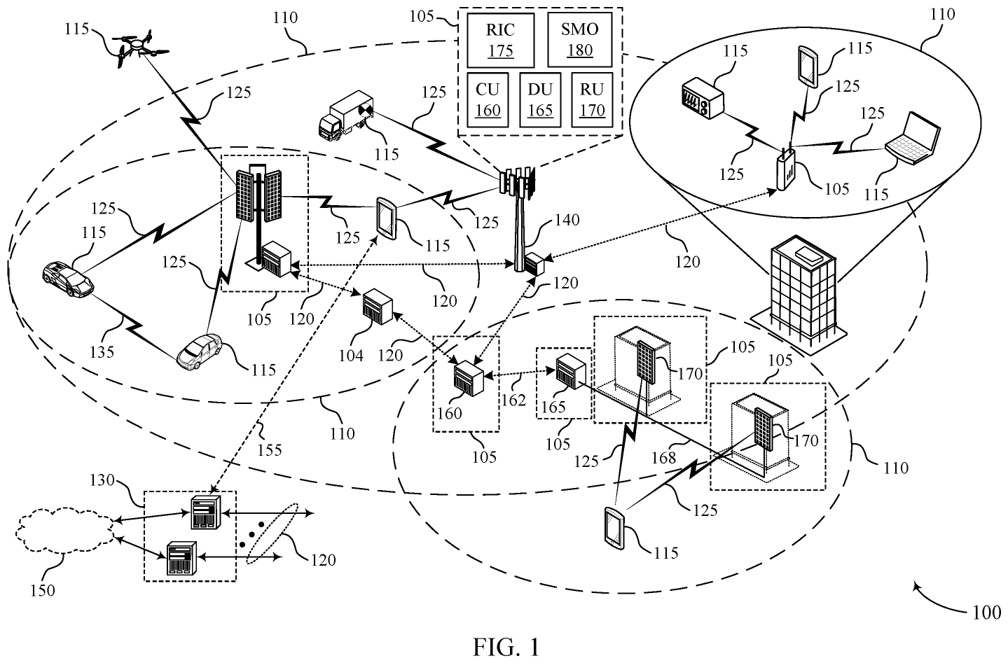

FIG. 1 shows an example of a wireless communications system 100 that supports techniques for resolving scheduling conflicts between measurement occasions or reporting and communications with EH-capable devices in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein. Components within a wireless communication system may be coupled (for example, operatively, communicatively, functionally, electronically, and/or electrically) to each other.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for resolving scheduling conflicts between measurement occasions or reporting and communications with EH-capable devices as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δƒ) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect. techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The wireless communications system 100 may include EH-capable devices Some EH-capable devices may not have their own power sources. For example, an EH-capable device may not include a battery and/or may include limited energy storage (e.g., a capacitor). In some examples, an EH-capable device may operate using less than 100 micro-Watts (μW) of power. A source device may transmit a continuous wave (CW) signal to an EH-capable device, and the EH-capable device may use energy from the CW signal to activate radio frequency components and communicate with the source device or another device, such as by backscattering the CW signal.

In some examples, an EH-capable device may include a power rectifier, a forward-link demodulation element, a logic element/controller, memory, and a modulator (e.g., either a phase shift key modulator or an amplitude shift key modulator). A source device and/or a reader device may include a transmitter and a transmitting antenna for transmission of an interrogating signal, a receiver and a receiver antenna for reception of a backscatter response, a baseband processor for processing the received backscatter response, a leaking carrier canceller for canceling leakage between the transmitted interrogating signal and the backscatter response, or a combination thereof. In some aspects, a source device or a reader device may transmit a CW signal to power up an EH-capable device and then may transmit modulated commands (e.g., having values of “1” and “0”). The EH-capable device may absorb the power transmitted by the source device or the reader device, and may reflect a backscatter response. The backscatter response may convey information from the memory of the EH-capable device modulated using the modulator. In some aspects, a source device or a reader device may be a UE 115 or a network entity 105.

In some cases, EH-capable device communications may involve bi-static communications that includes the EH-capable device and multiple network nodes such as a source network node (e.g., a UE 115 that transmits an interrogating signal) and a reader network node (e.g., a UE 115 that receives the backscatter response). The source network node may transmit an interrogating signal (e.g., a CW signal) to the EH-capable device for the EH-capable device to backscatter the signal. The reader network node may receive and decode the backscatter response to the interrogating signal. In some examples, the source network node (e.g., the source device) and the reader network node (e.g., the reader device) may be the same device (e.g., UE 115).

A UE 115 may receive control signaling from a network entity 105 to schedule occasions for RRM operation (e.g., RRM measurement, RRM reporting, RLM reporting) and for communication with an EH-capable device. In some cases, occasions for RRM operation and communication with the EH-capable device may conflict (e.g., may be scheduled too closely to each other or may overlap in time and/or frequency domains). The UE 115 may identify a conflict resolution scheme to resolve the conflict between the RRM operation and communication with the EH-capable device. For example, the UE 115 may determine to skip the RRM operation or the communication with the EH-capable device depending on one or more respective parameters associated with the RRM operation and the communication and one or more criteria indicated by the conflict resolution scheme. The UE 115 may communicate in accordance with the conflict resolution scheme.

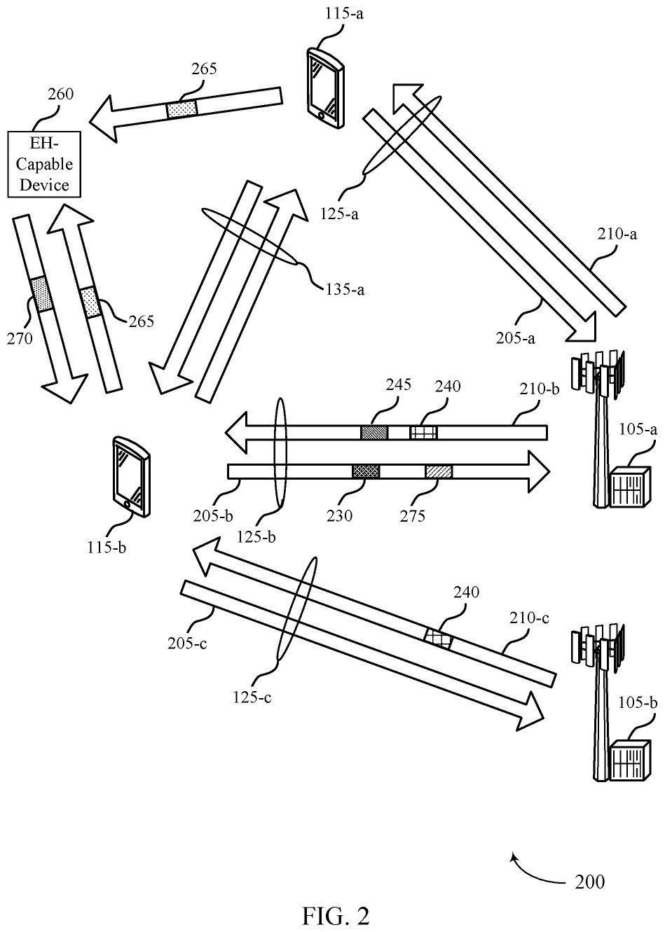

FIG. 2 shows an example of a wireless communications system 200 that supports techniques for resolving scheduling conflicts between measurement occasions or reporting and communications with EH-capable devices in accordance with one or more aspects of the present disclosure. The wireless communications system 200 may implement aspects of or may be implemented by aspects of the wireless communications system 100. For example, the wireless communications system 200 includes a UE 115-a and a UE 115-b, which may be examples of a UE 115 described with respect to FIG. 1. The wireless communications system 200 also includes a network entity 105-a and a network entity 105-b, which may be examples of a network entity 105 as described with respect to FIG. 1.

The UE 115-a may communicate with the network entity 105-a using a communication link 125-a, and the UE 115-b may communicate with the network entity 105-a using a communication link 125-b, which may be examples of communication links 125 described with respect to FIG. 1. The communication link 125-a and the communication link 125-b may include bi-directional links that enable both uplink and downlink communications. For example, the UE 115-a may transmit uplink signals 205-a (e.g., uplink transmissions), such as uplink control signals or uplink data signals, to the network entity 105-a using the communication link 125-a, and the network entity 105-a may transmit downlink signals 210-a (e.g., downlink transmissions), such as downlink control signals or downlink data signals, to the UE 115-a using the communication link 125-a. The UE 115-b and the network entity 105-b may similarly communicate uplink signals 205-b and downlink signals 210-b using the communication link 125-b.

The UE 115-a may communicate with the UE 115-b using a communication link 135-a, which may be an example of a communication link 135 as described with respect to FIG. 1. For example, the communication link 135-a may be a sidelink communication link and may support bidirectional communications between the UE 115-a and the UE 115-b.

The UE 115-b may communicate with the network entity 105-b using a communication link 125-c, which may be an example of a communication link 125 described with respect to FIG. 1. The UE 115-b and the network entity 105-b may similarly communicate uplink signals 205-c and downlink signals 210-c using the communication link 125-c. In some aspects, the UE 115-b may communicate concurrently with the network entity 105-a and with the network entity 105-b. In some scenarios, the UE 115-b may transition communications (e.g., perform a handover) between the network entity 105-a and the network entity 105-b (e.g., may switch from communicating via a cell provided by the network entity 105-a to a cell provided by the network entity 105-b, or vice versa). For example, communications between the UE 115-b and the network entity 105-a may degrade as the UE 115-b moves away from the network entity 105-a and communicates with the network entity 105-b in a transition (e.g., handover) procedure.

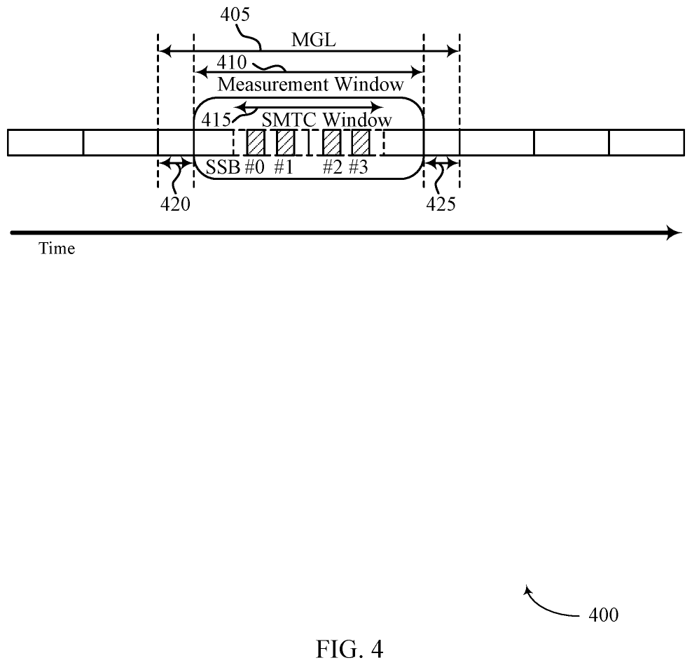

A network entity 105 (e.g., the network entity 105-a and/or the network entity 105-b) may send one or more measurement signals 240 to the UE 115-b. Examples of a measurement signal 240 may include an RRM signal and a radio link monitoring (RLM) signal. In some aspects, an RRM signal may be utilized to measure signal quality. For example, the RRM signal may include one or more synchronization signal blocks (SSBs), which may be utilized to measure signal quality to determine whether to handover the UE 115-b. In some examples, the RLM signal may be utilized to monitor link quality (between the UE 115-b and the network entity 105-b or network entity 105-a) to determine whether out-of-sync occurs in the primary cell. The UE 115-b may perform a measurement using the one or more measurement signals 240 (e.g., RRM and/or RLM). As used herein, the terms “radio resource management” and/or “RRM” may refer to (and/or be substituted with) the terms “radio link monitoring” and/or “RLM.” An example of a measurement gap for performing measurement of a measurement signal 240 is given in FIG. 4.

The UE 115-b may generate (e.g., produce) a report 230 based on the measurement signal 240. The report 230 may indicate one or more measurements (e.g., signal-to-interference ratio (SINR), reference signal received power (RSRP), and/or reference signal received quality (RSRQ) measurements) performed by the UE 115-b based on the one or more measurement signals 240. The UE 115-b may transmit the report 230 to the network entity 105-a. The network entity 105-a may utilize the report 230 to manage communication resources and/or to manage handover of the UE 115-b.

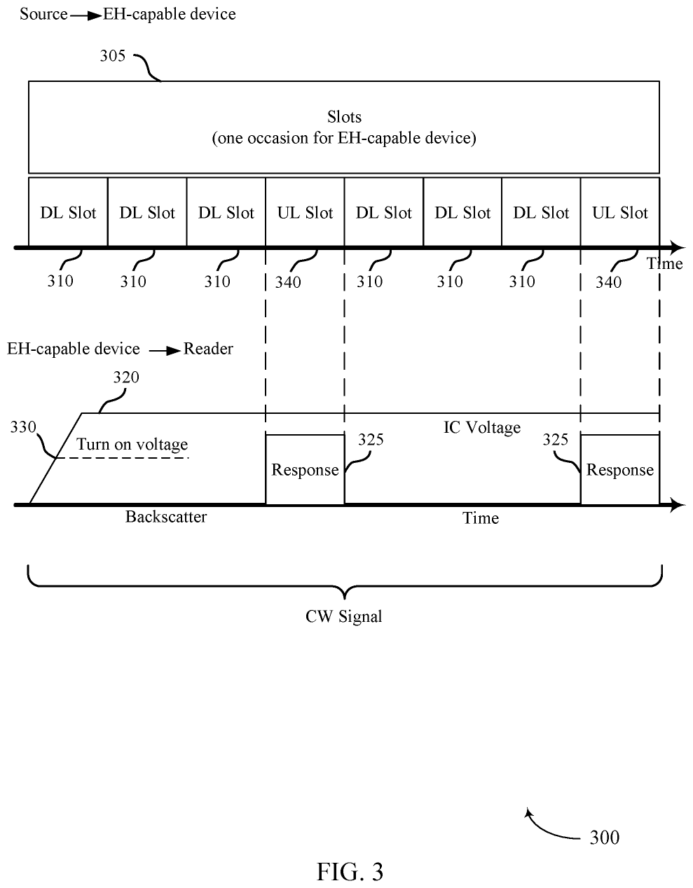

The wireless communications system 200 may support communications with an EH-capable device 260. For example, the EH-capable device 260 may be an RFID device or a passive device as described herein. A source device (e.g., the UE 115-a or UE 115-b) may transmit a CW signal 265 to the EH-capable device 260. The CW signal 265 may provide power to the EH-capable device 260. The EH-capable device may produce a backscatter response 270. The backscatter response 270 may be received by a reader device (e.g., the UE 115-b in the example of FIG. 2, although the UE 115-a may additionally or alternatively operate as a reader device). The backscatter response 270 may indicate a payload (e.g., data) stored on the EH-capable device. An example of the backscatter response 270 is given in FIG. 3.

In some aspects, the wireless communications system 200 may support bi-static communications involving the EH-capable device 260. In some aspects, information may be modulated onto a backscatter response 270. For example, information may be modulated onto the backscatter response using amplitude shift keying (ASK), among other types of modulation schemes. To use ASK, backscatter reflection is turned on to transmit an information bit “1” and backscatter reflection is turned off to transmit an information bit “0.” For example, a transmission from the UE 115-a to the EH-capable device 260 may be denoted as x(n). The information bits for the EH-capable device to backscatter may be given by s(n)∈{0,1}. Accordingly, the backscatter response 270 received by the UE 115-b may be given by y(n)=(h_{D1D2}(n)+σ_{ƒ}h_{D1T}(n)h_{TD2}(n)s(n))x(n)+noise, where h_{D1D2}(n) represents the channel between the UE 115-a and the UE 115-b, h_{D1T}(n) represents the channel between the UE 115-a and the EH-capable device 260, h_{TD2}(n) represents the channel between the EH-capable device 260 and the UE 115-b, and σ_{ƒ} denotes the reflection coefficient of the EH-capable device 260. In some examples, when s(n)=0, reflection is switched off at the EH-capable device 260, so the UE 115-b may receive only the direct link signal (e.g., y(n)=h_{D1D2}(n)x(n)+noise). When s(n)=1, reflection is switched on at the EH-capable device 260, so the UE 115-b may receive the superposition of both the direct link signal and the backscatter link signal (e.g., y(n)=(h_{D1D2}(n)+σ_{ƒ}h_{D1T}(n)h_{TD2}(n)s(n))x(n)+noise).

In bi-static communications involving an EH-capable device 260, the source device (e.g., the UE 115-a) may transmit a CW signal 265 to the EH-capable device 260. The EH-capable device 260 may reflect and/or backscatter the CW signal 265 with the payload of the EH-capable device 260 modulated onto the backscatter response 270. The reader device (e.g., the UE 115-b) may receive the backscatter response 270. For example, the UE 115-b may read the backscatter response 270 and determine the payload of the EH-capable device 260. In some scenarios, a reader device (e.g., the UE 115-b) may send the payload to a source device (e.g., the UE 115-a) and/or the network entity 105-a. In some cases (e.g., low-latency cases, such as lost tag or medical applications), a reader device may communicate with the EH-capable device 260 within a period (e.g., a few milliseconds (ms) or seconds). Such bi-static communications may involve more than 1 slot (e.g., the EH-capable device 260 may use 1 slot in 30 kHz subcarrier spacing (SCS) or 0.5 ms for powering up). Such bi-static communications may involve saving power at the receiving UE 115-b by configuring the communication beforehand so that the receiving UE 115-b does not perform blind decoding or so that the receiving UE 115-b may determine the resource allocation of the communication for reception of the backscatter response 270 so that the receiving UE 115-b does not transmit during the backscatter response 270. In some aspects, bi-static communications may involve either the sidelink interface, the Uu interface (e.g., access interface for communications between the UE 115-b and the network entity 105-a), or a new interface.

In some scenarios, a conflict may arise between measurement signal 240 measurement and communication with the EH-capable device 260 or between transmission of the report 230 and the communication with the EH-capable device 260. During a measurement gap, the UE 115-b may not transmit or receive other signals besides the measurement signal 240. For example, the UE 115-b may perform RF tuning during the measurement gap, which may restrict receiving, monitoring, and/or transmitting other signals. Accordingly, if an overlap in time occurs between the measurement signal 240 or the report 230 and communication with the EH-capable device 260, or if the measurement signal 240 or the report 230 occurs within a threshold quantity of time (e.g., threshold quantity of slots and/or symbols) relative to communication with the EH-capable device 260, a conflict may occur. Additionally, or alternatively, communication with the EH-capable device 260 may overlap with or occur within a threshold quantity of time relative to the transmission of the report 230. Due to the conflict, the UE 115-b may perform one of measurement signal 240 reception and measurement, reporting of the report 230, or communication with the EH-capable device 260 (e.g., low-latency tag).

A conflict may occur in scenarios where the EH-capable device 260 has a restrictive latency window (e.g., latency constraints), where the UE 115-b is operating as a source device or reader device, where the UE 115 is scheduled with a measurement gap (e.g., RRM measurement), where the UE 115 is scheduled for measurement reporting, or a combination thereof. For example, a restrictive latency window (e.g., a few milliseconds or seconds) may be implemented for an EH-capable device 260, such as a lost tag, a tag in a medical application (e.g., a tag associated with medical sensors), or a tag associated with emergency signals. When a conflict arises, the UE 115-b may be unable to communicate with the EH-capable device 260 while concurrently performing a measurement of the measurement signal 240 and/or reporting. Accordingly, techniques to address conflicts between measurement (e.g., RRM and/or RLM measurement), reporting, and EH-capable device communication (e.g., tag reading) may be helpful.

The techniques described herein relate to methods, systems, devices, and apparatuses for resolving scheduling conflicts between measurement or reporting occasions and communications with EH-capable devices 260. Some aspects of the techniques described herein may relate to prioritization between EH-capable device communication (e.g., A-IoT processing) and measurements or may relate to prioritization between EH-capable device communication and measurement reporting. In some aspects, signaling and/or rules may be utilized for prioritization. For example, signaling (e.g., a layer-1 (L1), layer-2 (L2), and/or layer-3 (L3) indication) from the network entity 105-a may be utilized to indicate whether to perform measurement or EH-capable device communication based on a priority and/or latency, among other criteria described herein.

The network entity 105-a may transmit control signaling 245 to the UE 115-b. The control signaling may indicate one or more occasions. An occasion may be a period (e.g., time window(s), slot(s), mini-slot(s), symbol(s)) scheduled for communication and/or processing. For example, an occasion may be a period scheduled to communicate with the EH-capable device 260 (e.g., to operate as a source device and/or a reader device), to perform measurement of a measurement signal 240, or to report a measurement (e.g., transmit the report 230).

The UE 115-b may receive, from the network entity 105-a, the control signaling 245. The control signaling 245 may indicate that a first occasion is scheduled for an RRM operation, such as an RRM measurement or RRM measurement reporting, and that a second occasion is scheduled for communication with the EH-capable device 260. The control signaling 245 may indicate that the first occasion at least partially overlaps in time (e.g., in time windows, slots, frames, or subframes) with the second occasion or is within a threshold time gap (e.g., a threshold quantity of slots, mini-slots, or symbols) of the second occasion. As such, the first occasion and the second occasion may be in conflict.

When the UE 115-b is simultaneously configured with conflicting EH-based communication (e.g., A-IoT processing) and RRM operation, the UE 115-b may resolve the conflict according to various techniques. For instance, the UE 115-b may identify a conflict resolution scheme for resolving a scheduling conflict between the first occasion and the second occasion based on the first occasion at least partially overlapping with the second occasion or a time gap between the first occasion and the second occasion failing to satisfy (e.g., being less than, being less than or equal to) a threshold time gap.

The UE 115-b may detect that the first occasion and the second occasion overlap by determining that a starting time of the first occasion is between a starting time and an ending time of the second occasion or by determining that a starting time of the second occasion is between a starting time and an ending time of the first occasion. In some aspects, detecting an overlap may be based on frequency ranges corresponding to the occasions. For example, an overlap may be detected if the first occasion and the second occasion partially or completely overlap in time and frequency domains. In some aspects, an overlap and/or conflict may occur if the UE 115-b is scheduled to operate as a source device and/or a reader device while (or within a threshold duration of time that) the UE 115-b is scheduled to receive a measurement signal 240, to measure the measurement signal 240, and/or to transmit the report 230. In a case that overlap and/or conflict is detected, the UE 115-b may identify a conflict resolution scheme. A conflict resolution scheme may indicate how to select one of the conflicting occasions based on a rule, logic, or algorithm to resolve a conflict (e.g., a scheduling conflict between the first occasion and the second occasion).

The UE 115-b may communicate, in accordance with the conflict resolution scheme, a report 230 to the network entity 105-a including the RRM measurement performed during the first occasion, a report 230 to the network entity 105-a during the first occasion, or a signal (e.g., the CW signal 265 and/or the backscatter response 270) during the second occasion. For example, the UE 115-b may decide whether to measure the measurement signal 240 (e.g., if the first occasion corresponds to the communication of the measurement signal 240), transmit a report 230 (e.g., if the first occasion corresponds to the reporting of a measurement performed prior to the first occasion), or communicate with the EH-capable device 260.

In some aspects, the conflict resolution scheme may indicate for the UE 115-b to perform EH-based communication processing (e.g., A-IoT processing) based on a priority of the EH-based communication processing (e.g., communication session or quality of service associated with the communication session). For instance, the UE 115-b may communicate, in accordance with the conflict resolution scheme, the signal based on a first priority associated with a communication session with the EH-capable device 260 being higher than a second priority of the RRM measurement. For example, the UE 115-b may determine and/or store a first priority associated with a communication session of with the EH-capable device 260 and may determine and/or store a second priority associated with the RRM operation (e.g., the RRM measurement, the RRM measurement reporting). The priority of the EH-based communication processing may also be a function of a remaining packet delay associated with sending information to the EH-capable device 260 or receiving data/payload from the EH-capable device 260, where shorter remaining packet delay may result in higher priority for the EH-based communication processing.

When the first priority is higher than the second priority, the UE 115-b may communicate with the EH-capable device 260 (and/or may cancel, drop, or skip RRM measurement and/or reporting). When the second priority is higher than the first priority, the UE 115-b may perform the RRM measurement and/or reporting (and/or may cancel, drop, or skip communicating with the EH-capable device 260). Additionally, or alternatively, if the first priority satisfies (e.g., meets or exceeds) a first threshold priority, the UE 115-b may communicate with the EH-capable device 260 and cancel the RRM operation. Otherwise, the UE 115-b may perform the RRM operation and cancel the communication with the EH-capable device 260. Additionally, or alternatively, if the second priority satisfies a second threshold priority (e.g., which may be the same as or different than the first threshold priority), the UE 115-b may perform the RRM operation and cancel the communication with the EH-capable device 260. Otherwise, the UE 115-b may communicate with the EH-capable device 260 and cancel the RRM operation. In some aspects, one priority (e.g., the first priority or the second priority) may be statically set higher than another priority (e.g., the second priority or the first priority). In some aspects, the first priority may be determined based on a QoS of the EH-capable device 260 communication and/or based on a remaining packet delay associated with communicating with the EH-capable device 260 (e.g., a remaining packet delay associated with sending data to or receiving a payload from the EH-capable device 260).

In some aspects, the conflict resolution scheme may indicate for the UE 115-b to perform EH-based communication processing (e.g., A-IoT processing) based on a QoS of the EH-based communication processing (e.g., communication session). For instance, the UE 115-b may communicate, in accordance with the conflict resolution scheme, the signal based on a QoS associated with a communication session with the EH-capable device 260. For example, a communication session between the UE 115-b and the EH-capable device 260 may have an associated QoS. If the QoS is greater than a threshold (e.g., greater than a lowest QoS), then the second occasion and/or communication with the EH-capable device 260 may have a higher priority than the first occasion (e.g., RRM measurement and/or reporting).

In some aspects, the conflict resolution scheme may indicate for the UE 115-b to perform EH-based communication processing (e.g., A-IoT processing) based on a remaining packet delay associated with sending info to the EH-capable device 260 or receiving a payload from the EH-capable device 260. For instance, the UE 115-b may communicate, in accordance with the conflict resolution scheme, the signal based on a remaining packet delay associated with a communication session with the EH-capable device. For example, a communication session between the UE 115-b and the EH-capable device 260 may have an associated remaining packet delay (e.g., a quantity of remaining packets and/or time to communicate remaining packets). If the remaining packet delay budget is lower than a threshold (e.g., lower than a threshold time) and/or the remaining quantity of packets is greater than a threshold, then the second occasion (e.g., communication with the EH-capable device 260) may have a higher priority than the first occasion (e.g., RRM measurement and/or reporting). In some aspects, a combination of factors may be utilized (e.g., a weighted combination of QoS and remaining packet delay) to determine whether the communication with the EH-capable device 260 and/or second occasion is prioritized over the first occasion (e.g., RRM measurement and/or reporting). Prioritizing the second occasion with a greater packet delay budget may help to ensure that a larger communication and/or payload of the EH-capable device 260 is prioritized.

In some aspects, the UE 115-b may communicate, in accordance with the conflict resolution scheme, the signal based at least in part on a prior RRM measurement satisfying a threshold. For example, if one or more previous RRM measurements satisfy a threshold, the UE 115-b may communicate the signal with the EH-capable device 260. In some examples, the conflict resolution scheme may indicate that the UE 115-b does not perform the RRM measurement if the quality of L (e.g., one or more) prior measurements are good (e.g., satisfy a threshold). For example, if one or more SINR, RSRP, and/or RSRQ measurements (e.g., filtered measurements and/or averaged measurements) meet or exceed a threshold, then the communication with the EH-capable device 260 may be prioritized. In some examples, the threshold may be an L1, L2, and/or L3 configured threshold. In some examples, the L prior measurements may be based on L3 filtrations or averaged L1 and/or L3 measurements. Prioritizing the EH-capable device 260 communications when the previous measurement(s) satisfy a threshold may allow the measurement and/or reporting to be dropped when previous measurements indicate a link that satisfies a threshold quality.

In some aspects, the UE 115-b may communicate, in accordance with the conflict resolution scheme, the report 230 based at least in part on a prior RRM measurement failing to satisfy a threshold. For example, if one or more previous RRM measurements fail to satisfy a threshold, the UE 115-b may communicate the report 230 with the network entity 105-a. That is, the conflict resolution scheme may indicate that the UE 115-b performs the RRM measurement of the serving cell (from the network entity 105-a) and/or of the neighbor cell(s) (from the network entity 105-b) if the quality of the serving cell during one or more previous measurements is degrading (e.g., SINR, RSRP, and/or RSRQ is below an L1, L2, and/or L3 configured threshold). The one or more previous measurements may be based on L3 filtrations or averaged L1 and/or L3 measurements. Prioritizing the measurement and/or reporting when the previous measurement(s) fail to satisfy a threshold may allow the measurement and/or reporting to be performed when previous measurements indicate a link with a below-threshold quality and/or a declining quality.

In some aspects, the conflict resolution scheme may indicate for the UE 115-b to resolve the conflict based on a previous decision (e.g., previous resolution) or a window of previous decisions (e.g., decisions made within the last T milliseconds). For instance, the UE 115-b may communicate, in accordance with the conflict resolution scheme, one of the report 230 or the signal based on one or more previous conflict resolutions (e.g., a window of conflict resolutions). For example, if a quantity (e.g., a threshold of one or more) previous conflict resolutions has been resolved in favor of the measurement and/or report 230, a current conflict resolution may be resolved in favor of the signal. If the same or another quantity of previous conflict resolutions has been resolved in favor of the signal, a current conflict resolution may be resolved in favor of the measurement and/or report 230. That is, the conflict resolution scheme may indicate for the UE 115-b to alternate between resolution decisions (e.g., between each resolution decision or between sets of resolution decisions). One or more of the previous conflict resolutions may be performed in accordance with one or more of the conflict resolution schemes described herein.

In some aspects, identifying the conflict resolution scheme may include receiving, from the network entity 105-a, second control signaling indicating to communicate the report 230 including the RRM measurement to the network entity 105-a or the signal with the EH-capable device 260 during the second occasion. That is, the second control signaling may indicate for the UE 115-b to perform the RRM measurement during the first occasion (e.g., for subsequent reporting), communicate the report 230 during the first occasion, or communicate the signal during the second occasion. For example, the network entity 105-a may send second control signaling (e.g., L1, L2, and/or L3 signaling, including scheduling or non-scheduling DCI) that instructs the UE 115-b to prioritize the measurement and/or report 230 over the signal with the EH-capable device 260, or that instructs the UE 115-b to prioritize the signal with the EH-capable device 260 over the measurement and/or report 230. In some aspects, the network entity 105-a may send control signaling (e.g., L1, L2, and/or L3 signaling, including scheduling or non-scheduling DCI) that instructs the UE 115-b to utilize one or more of the conflict resolution schemes described herein.

Since EH-based communication processing (e.g., A-IoT processing) may last for an amount of time, a UE 115 may transmit during one or more downlink occasions (e.g., occasion 305 that is a downlink occasion), within which an RRM operation may be scheduled or configured to occur, for example. When such a scenario occurs, then the UE 115 may operate in accordance with the conflict resolution schemes described herein.

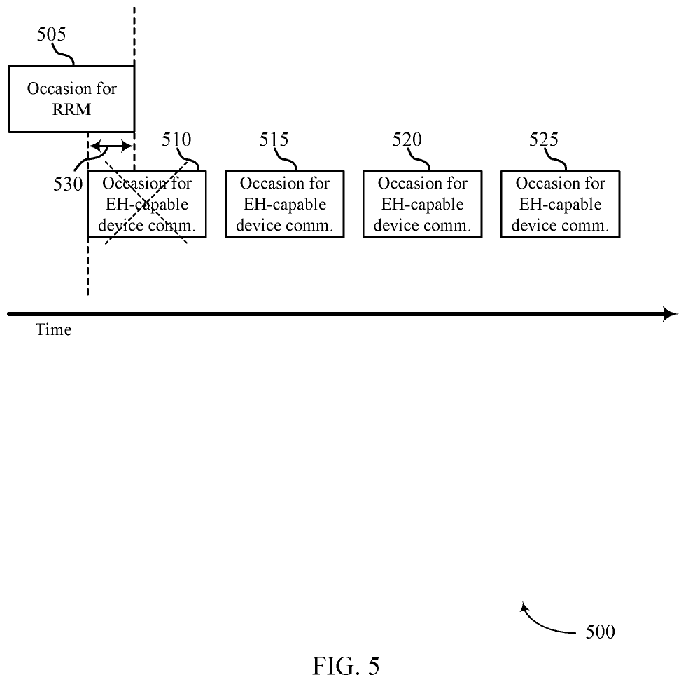

In some aspects, the UE 115-b may communicate, in accordance with the conflict resolution scheme, the report 230 based on one or more repetitions being scheduled for communicating the signal with the EH-capable device 260. That is, the UE 115-b may perform the RRM measurement during the first occasion or transmit the report 230 during the first occasion (e.g., based on an RRM measurement performed during a prior occasion) based on the one or more repetitions. For example, if the EH-capable device 260 communication session has an associated repetition factor, the repetition factor, periodicity, and/or one or more previous conflict resolutions (e.g., resolution decisions) may be utilized to determine whether to prioritize the signal or the measurement and/or report 230. For example, if the repetition factor is at least Z repetitions per occasion and/or process, and the RRM measurement or reporting conflicts with one of the repetitions, then the RRM measurement and/or report 230 may be prioritized. An example of utilizing a repetition factor in the conflict resolution scheme is given in FIG. 5.

In some aspects, the UE 115-b may communicate, in accordance with the conflict resolution scheme, the report 230 based on a radio link failure (RLF) for the UE 115-b or a cell change for the UE 115-b. For example, for RLM, the UE 115-b may communicate the report 230 if the UE 115-b has determined to change a cell and/or announces (e.g., reports, indicates) RLF. In a scenario where the UE 115-b performs handover based on an RRM measurement, the UE 115-b may transmit the report 230 to report RRM measurements. The network entity 105-a may monitor uplink occasions in case the UE 115-b sends the report 230 (e.g., RRM and/or RLM channel state information (CSI) report). If transmitting the report 230 during the first occasion, the UE 115-b may drop the communication with the EH-capable device 260 during the second occasion.

In some aspects, the UE 115-b may transmit, to the network entity 105-a. control signaling 275 (e.g., second control signaling) indicating the UE 115-b may not perform the RRM measurement at the first occasion. The signal may be communicated based on the control signaling 275. For example, the UE 115-b may transmit an indication (e.g., control signaling 275) to skip the RRM measurement and/or reporting. In some aspects, the UE 115-b may use an L1, L2, and/or L3 indication (including UE assistance information (UAI)). In some aspects, the UE 115-b may multiplex L1, L2, and/or L3 signals (e.g., may multiplex CSI, power headroom report (PHR), buffer status report (BSR), end of burst indication, scheduling request (SR), random access channel (RACH) message, and/or UAI, among other examples) to send the indication. In some examples, the UE 115-b may send the indication (of skipping the RRM measurement gap) to the network entity 105-a.

In some aspects, the UE 115-b may transmit, to the UE 115-a and to the network entity 105-a, control signaling 275 (e.g., second control signaling) indicating the UE 115-b may not perform the communication with the EH-capable device 260 at the second occasion. The report may be communicated based on the control signaling 275. For example, the UE 115-b may transmit an indication to skip the signal. In some aspects, the UE 115-b may use an L1, L2, and/or L3 indication (including UAI). In some aspects, the UE 115-b may multiplex L1, L2, and/or L3 signals (e.g., may multiplex CSI, PHR, BSR, end of burst indication, SR, RACH message, and/or UAI, among other examples) to send the indication. In some examples, the UE 115-b may send the indication (of skipping the signal from the EH-capable device 260) to the UE 115-a and/or to the network entity 105-a.

In some aspects, the UE 115-b may communicate, in accordance with the conflict resolution scheme, the signal based on one or more repetitions being scheduled for the RRM measurement or reporting. For example, if the RRM measurement or reporting is configured with repetition (e.g., a repetition factor), then the UE 115-b may drop one or more colliding (e.g., conflicting) repetitions and transmit the signal instead. If the reporting and the EH-capable device 260 sessions have repetitions, then based on an indication or rule, the UE 115-b may alternate dropping such that the UE 115-b may send the report 230 and the signal at different times.

In some aspects, the UE 115-b may transmit the report 230 while continuing a processing session with the EH-capable device 260. For example, transmitting the report 230 (e.g., during the first occasion) while continuing the processing session (e.g., communicating the signal with the EH-capable device during the second occasion) may occur when transmission of the report 230 occurs on a same interface and/or when the EH-capable device 260 and/or UE 115-b has power to continue the processing session.

In some aspects, the UE 115-b may communicate, in accordance with the conflict resolution scheme, the signal based on how the second occasion is scheduled. For example, if the second occasion to communicate with the EH-capable device 260 is scheduled (e.g., dynamically) via DCI, the UE 115-b may communicate the signal and cancel the RRM operation. Alternatively, the UE 115-b may decide the conflict resolution based on parameters included in the DCI (e.g., the conflict resolution scheme may be indicated via the DCI) or based on an indication in the DCI to cancel the RRM operation.

FIG. 3 shows an example of a timing diagram 300 that supports techniques for resolving scheduling conflicts between measurement occasions or reporting and communications with EH-capable devices in accordance with one or more aspects of the present disclosure. The timing diagram 300 may implement or may be implemented by aspects of the wireless communications system 100 or the wireless communications system 200.

In backscatter communications, a source device (e.g., the UE 115-a or the UE 115-b of FIG. 2) may perform a talks-first procedure. The source device may transmit a CW signal over several slots (e.g., over a duration (e.g., 400 μs) of each downlink (DL) and uplink (UL) slot), which the EH-capable device 260 receives. The EH-capable device 260 may receive the CW signal and reach a turn-on voltage 330 of the EH-capable device 260. After (e.g., once) the EH-capable device 260 reaches the turn-on voltage 330, the source device may transmit a command (e.g., modulated signal) in one or more DL slots 310 to the EH-capable device 260 which may include information for the EH-capable device 260. In some examples, the receive power of the command at the EH-capable device 260 may be greater than −20 dBm to maintain the voltage at the EH-capable device 260 above the turn-on voltage 330 (e.g., at a voltage 320 sufficient to power the integrated circuit (IC) of the EH-capable device 260). The source device may transmit the CW signal to maintain the “on” state of the EH-capable device 260. The EH-capable device 260 may backscatter the CW signal in UL slots 340 as backscatter responses 325. A reader device (e.g., the UE 115-b of FIG. 2) may receive the backscatter responses 325. The command may indicate that the UL slots 340 will be used for backscattering.

Accordingly, an occasion 305 for communications involving an EH-capable device 260 may include multiple slots. In some examples, the control signaling 245 described in FIG. 2 may define the size of the occasion 305 in the quantity of slots. For example, the control signaling 245 may schedule the second occasion for the source device (e.g., UE 115-a or UE 115-b) and/or for the reader device (e.g., UE 115-b) and/or may indicate the quantity of slots of the occasion 305 that will be used for communications (e.g., bi-static communications) involving an EH-capable device 260. In some aspects, the quantity of slots may be configured or updated via a DCI(s) that activates the occasion 305 or a reactivation DCI that activates the occasion 305. In some aspects, RRC signaling may configure a set of candidate quantities of slots of the occasion 305 that will be used for communications involving an EH-capable device 260, and a DCI(s) that activates the occasion 305 may select one of the candidate quantities of slots.

In some aspects, the quantity of slots/subslots/symbols for commands (e.g., modulated CW signal for the EH-capable device 260 to process), the quantity of slots/subslots/symbols for the CW signal for backscattering, and the quantity of slots/subslots/symbols for the CW signal for powering up the EH-capable device 260 may be defined within the occasion 305. A gap between the different types of signals (e.g., to switch radio frequency (RF) or communication direction) between slot types (e.g., a DL slot 310 and a UL slot 340) may also be defined. The gap may depend on the capability of the source (e.g., the UE 115-a or the UE 115-b of FIG. 2), the reader (e.g., the UE 115-b of FIG. 2), and/or the EH-capable device 260 (including the class of EH-capable device).

In some aspects, the command may include a preamble or synchronization signal. In some aspects, the synchronization signal may be a separate synchronization signal. In some aspects, the backscatter response 325 may include a synchronization signal. In some aspects, the command may include a general synchronization signal with a periodicity that assists in synchronizing the source and reader devices and/or the EH-capable device 260. In some aspects, some communication resources may be reserved for the source and reader devices to communicate (e.g., for communication between the UE 115-a and the UE 115-b via the communication link 135-a of FIG. 2).

In some aspects, the waveforms, coding type, and modulation type may be signaled to the EH-capable device 260 prior to transmission in the occasion 305. For example, the waveforms, coding type, and modulation type may be signaled to the EH-capable device 260 and/or may be indicated to the EH-capable device 260 from the network or from either the source or the reader devices. For example, knowledge of the waveforms, coding type, and modulation type may be used by the EH-capable device 260 to decode the command and the CW signal for backscattering.

The occasion 305 may conflict with an occasion during which the source device or reader device is scheduled to perform an RRM operation (e.g., an RRM measurement, RRM measurement reporting, an RLM measurement, RLM measurement reporting). In accordance with examples described herein, the source device or the reader device may determine whether to communicate with the EH-capable device 260 during the occasion 305 or perform the RRM operation in accordance with a conflict resolution scheme.

FIG. 4 shows an example of a timing diagram 400 that supports techniques for resolving scheduling conflicts between measurement occasions or reporting and communications with EH-capable devices in accordance with one or more aspects of the present disclosure. The timing diagram 400 may implement or may be implemented by aspects of the wireless communications system 100 or the wireless communications system 200.

In RRM measurement signaling, a network entity (e.g., the network entity 105-a or the network entity 105-b of FIG. 2) may send a measurement signal (e.g., measurement signal 240) during a measurement gap having a measurement gap length (MGL) 405. The network entity may transmit the measurement signal over several slots. In the example of FIG. 4, the measurement gap occupies four slots, where each slot has a duration of 1 ms. For example, the MGL in FIG. 4 is 4 ms. Other MGLs (e.g., having 6 ms durations, among others) may be utilized in other examples.

The measurement gap may include RF retuning times 420, 425 and a measurement window 410. In the example of FIG. 4, the measurement window 410 has a duration of 3 ms. Other measurement windows may have other durations (e.g., 5 ms) in other examples. The measurement window 410 may include an SSB-based RRM measurement timing configuration (SMTC) window 415 with a duration of 2 ms, which includes four SSBs in the example of FIG. 4. Other examples may utilize SMTC windows of a different duration (e.g., 4 ms) and/or with a different quantity of SSBs (e.g., 8 SSBs).

As described herein, a UE 115 (e.g., UE 115-b) may utilize a measurement signal to perform one or more measurements and/or to generate a report (e.g., report 230). For example, the UE 115-b may utilize synchronization signals in the SSBs to perform measurements to generate RSRPs. The UE 115-b may send the RSRPs in the report 230. A conflict may occur when a measurement gap occasion is scheduled to occur in an overlapping time frame with (and/or within a threshold period from) an occasion for communicating with an EH-capable device 260. For example, the UE 115 may be unable to perform communications other than the RRM measurement at least during the duration of the MGL 405 (e.g., and, in some cases, for a duration before and/or after the MGL 405, such as due to performing RF tuning). In accordance with examples, the UE 115 may determine whether to communicate with the EH-capable device 260 or perform the RRM measurement in accordance with a conflict resolution scheme. FIG. 5 shows an example of a timing diagram 500 that supports techniques for resolving scheduling conflicts between measurement occasions or reporting and communications with EH-capable devices in accordance with one or more aspects of the present disclosure. The timing diagram 500 may implement or may be implemented by aspects of the wireless communications system 100 or the wireless communications system 200.

As described herein, a network entity (e.g., network entity 105-a) may schedule occasions for an RRM operation (e.g., RRM measurement, RRM measurement reporting) and occasions for EH-capable device communication with a UE 115 (e.g., UE 115-b). In the example of FIG. 5, an occasion 505 for RRM (e.g., RRM measurement and/or reporting) is scheduled in an overlapping period 530 with an occasion 510 for EH-capable device communication (e.g., for transmitting a signal to a UE 115 and/or for receiving a signal from a UE 115). Additional occasions 515, 520, 525 are scheduled for EH-capable device communication. For example, the EH-capable device communication session includes a repetition factor with Z=4 in the example of FIG. 5. In the example of FIG. 5, the occasion 510 for the EH-capable device communication that overlaps with the occasion 505 for RRM is canceled (e.g., dropped, skipped) to allow the occasion 505 to be carried out by the UE 115 (e.g., UE 115-b). That is, a conflict resolution scheme may indicate for the UE 115 to perform the RRM operation during the occasions 505 and drop the communication with the EH-capable device during the occasion 510. In this example, the repetition factor may be greater than a threshold (e.g., Z>1). Accordingly, the UE 115 (e.g., UE 115-b) may follow a conflict resolution scheme to perform the RRM operation during the occasion 505 while skipping the occasion 510 for EH-capable device communication.

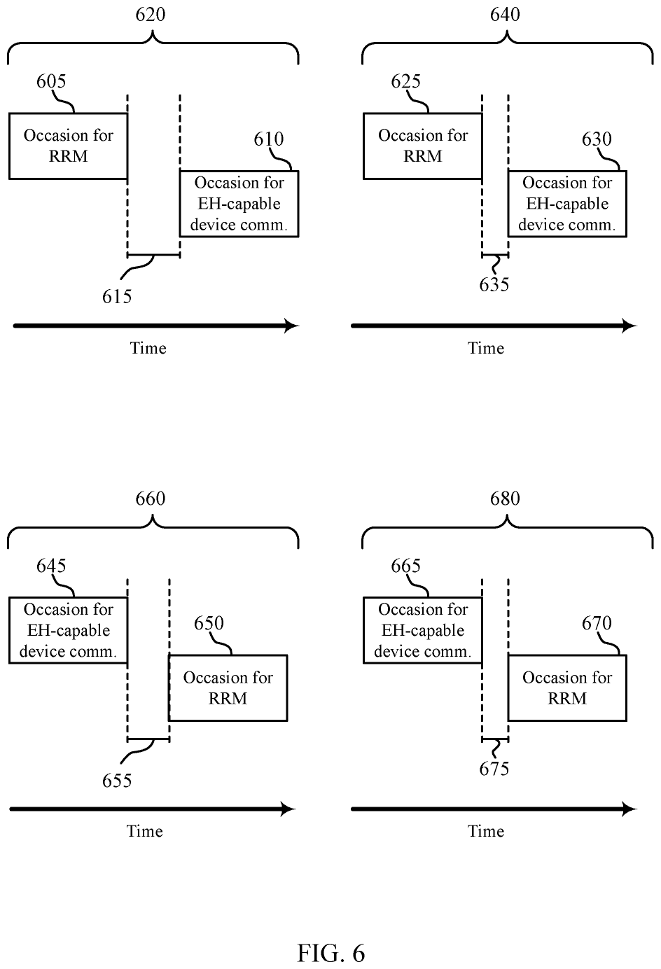

FIG. 6 shows examples of timing diagrams 620, 640, 660, 680 that support techniques for resolving scheduling conflicts between measurement occasions or reporting and communications with EH-capable devices in accordance with one or more aspects of the present disclosure. The timing diagrams 620, 640, 660, 680 may implement or may be implemented by aspects of the wireless communications system 100 or the wireless communications system 200.

In some aspects, EH-capable device communications and RRM operations may occur on different interfaces or on a same interface with a different sub carrier spacing (SCS), bandwidth part (BWP), component carrier (CC), band, or any combination thereof. Accordingly, different RF and timing constraints may be utilized for performing the EH-capable device communications and the RRM operations. In some aspects, a conflict resolution scheme may depend on a length of a time gap between an occasion for performing an RRM operation and an occasion for EH-based processing. For example, EH-capable device communication may be prioritized over RRM measurement and/or reporting for a time gap having a length failing to satisfy (e.g., below) a threshold time gap, or vice versa.

The threshold time gap may be different based on whether an occasion for RRM measurement or reporting precedes an occasion for EH-capable device communication or the occasion for EH-capable device communication precedes the occasion for RRM measurement or reporting. For example, a UE 115 (e.g., UE 115-b) may perform an RRM operation (e.g., RRM measurement or reporting) and EH-capable device communication if the time gap between respective occasions is X symbols or more when an occasion for the RRM operation occurs (e.g., comes) first. Alternatively, the UE 115 may perform the RRM operation and EH-capable device communication if the time gap is Y symbols or more, when an occasion for EH-capable device communication occurs first.

As described herein, a network entity (e.g., network entity 105-a) may schedule a UE 115 (e.g., UE 115-b) with occasions for RRM and occasions for EH-capable device communication. In the first timing diagram 620, an occasion 605 for RRM measurement and/or reporting precedes an occasion 610 for EH-capable device communication by X symbols 615. Accordingly, the UE 115 may perform RRM measurement and/or reporting for the occasion 605 and may perform EH-capable device communication for the occasion 610.

In the second timing diagram 640, an occasion 625 for RRM measurement and/or reporting precedes an occasion 630 for EH-capable device communication by a quantity of symbols 635 less than X. Accordingly, the UE 115 may perform one or more of the conflict resolution schemes described herein to cancel performing RRM measurement and/or reporting for the occasion 625 or to cancel performing EH-capable device communication for the occasion 630.

In the third timing diagram 660, an occasion 645 for EH-capable device communication precedes an occasion 650 for RRM measurement and/or reporting by Y symbols 655. Accordingly, the UE 115 may perform EH-capable device communication for the occasion 645 and may perform RRM measurement and/or reporting for the occasion 650.

In the fourth timing diagram 680, an occasion 665 for EH-capable device communication precedes an occasion 670 for RRM measurement and/or reporting by a quantity of symbols 675 less than Y. Accordingly, the UE 115 may perform one or more of the conflict resolution schemes described herein to cancel performing EH-capable device communication for the occasion 665 or to cancel performing RRM measurement and/or reporting for the occasion 670.

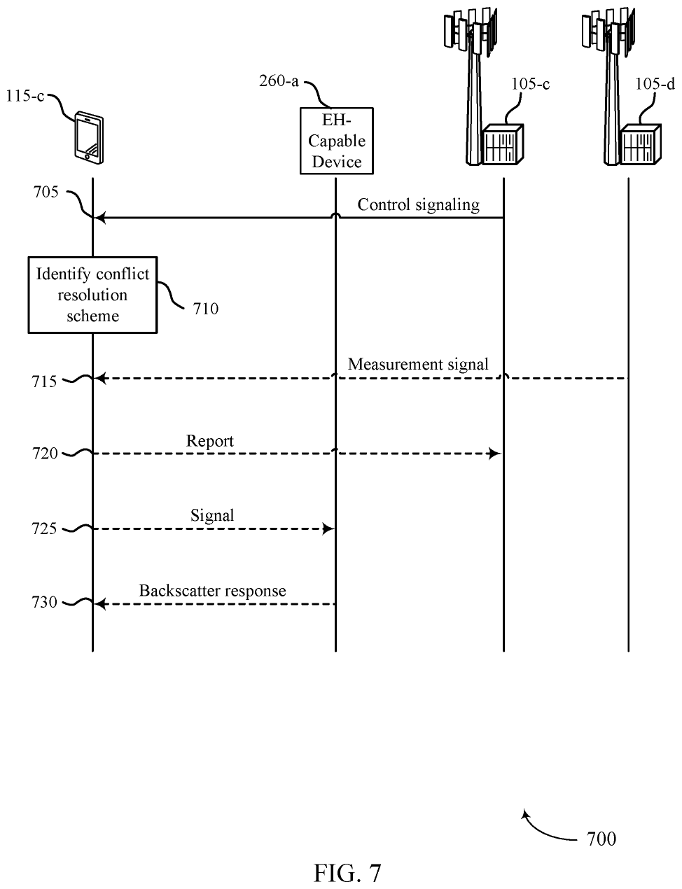

FIG. 7 shows an example of a process flow 700 that supports techniques for resolving scheduling conflicts between measurement occasions or reporting and communications with EH-capable devices in accordance with one or more aspects of the present disclosure. The process flow 700 may include a UE 115-c, which may be an example of UEs 115, as described herein. The process flow 700 may also include a network entity 105-c and a network entity 105-d, which may be examples of the network entities 105, as described herein. The process flow 700 may also include an EH-capable device 260-a, which may be an example of an EH-capable device 260 as described herein.

In the following description of the process flow 700, the operations between the network entity 105-c, the network entity 105-d, the UE 115-c, and the EH-capable device 260-a may be transmitted in a different order than the example order shown, or the operations performed by the network entity 105-c, the network entity 105-d, the UE 115-c, and the EH-capable device 260-a may be performed in different orders or at different times. Some operations may also be omitted from the process flow 700, and other operations may be added to the process flow 700. Further, although some operations or signaling may be shown to occur at different times for discussion purposes, these operations may actually occur at the same time.

At 705, the UE 115-c may receive, from the network entity 105-c, control signaling indicating that a first occasion is scheduled for a measurement signal measurement or reporting of a measurement signal measurement and that a second occasion is scheduled for communication with the EH-capable device 260-a.

At 710, the UE 115-c may identify a conflict resolution scheme for resolving a scheduling conflict between the first occasion and the second occasion based at least in part on the first occasion at least partially overlapping with the second occasion or a time gap between the first occasion and the second occasion failing to satisfy (e.g., being less than, being less than or equal to) a threshold time gap. In some examples, the threshold time gap may be based on (e.g., may be different depending on) which of the first occasion or the second occasion occurs first. In some examples, the threshold time gap may be based on a capability of the UE 115-c to perform RF tuning (e.g., a latency associated with the UE 115-c performing RF tuning).

At 715, the UE 115-c may receive a measurement signal. In some examples, the UE 115-c may receive the measurement signal from the network entity 105-d. In some examples, the UE 115-c may receive the measurement signal from the network entity 105-c. In some examples, the UE 115-c may receive the measurement signal during the first occasion (e.g., if the first occasion is scheduled for measurement signal measurement). Here, the UE 115-c may determine whether to receive the measurement signal or refrain from receiving (e.g., drop reception of) the measurement signal in accordance with a conflict resolution scheme due to the conflict between the first occasion and the second occasion. In some examples, the UE 115-c may receive the measurement signal before the first occasion (e.g., if the first occasion is scheduled for measurement signal measurement reporting).

At 720, the UE 115-c may communicate, in accordance with the conflict resolution scheme, a report including the measurement signal measurement (e.g., the RRM measurement) to the network entity 105-c, such as during the first occasion or after the first occasion (e.g., if the first occasion is scheduled for the measurement signal measurement). Or, in some aspects, at 725, the UE 115-c may communicate, in accordance with the conflict resolution scheme, a signal with the EH-capable device during the second occasion. For example, the UE 115-c may send the report or may send the signal based on whether the first occasion or the second occasion is prioritized (e.g., selected) in accordance with the conflict resolution scheme.

At 730, the EH-capable device 260-a may backscatter the signal (e.g., may transmit a backscatter response to the signal). The UE 115-c may receive the backscatter response. In some examples, the signal communicated during the second occasion may be the backscattered response.

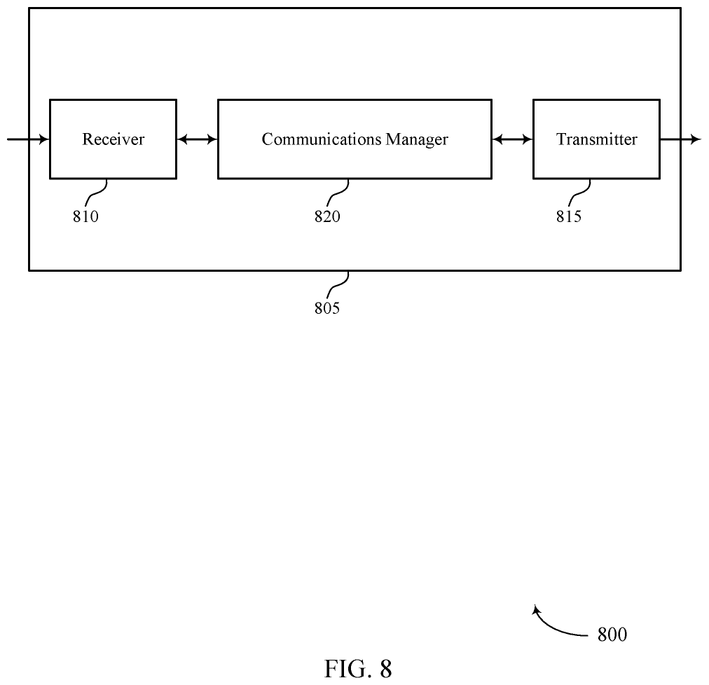

FIG. 8 shows a block diagram 800 of a device 805 that supports techniques for resolving scheduling conflicts between measurement occasions or reporting and communications with EH-capable devices in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for resolving scheduling conflicts between measurement occasions or reporting and communications with EH-capable devices). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for resolving scheduling conflicts between measurement occasions or reporting and communications with EH-capable devices). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for resolving scheduling conflicts between measurement occasions or reporting and communications with EH-capable devices as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software) executed by a processor. If implemented in code executed by a processor, the functions of the communications manager 820, the receiver 810, the transmitter 815, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. For example, the communications manager 820 is capable of, configured to, or operable to support a means for receiving, from a network entity, control signaling indicating that a first occasion is scheduled for an RRM operation and that a second occasion is scheduled for communication with an EH-capable device. The communications manager 820 is capable of, configured to, or operable to support a means for identifying a conflict resolution scheme for resolving a scheduling conflict between the first occasion and the second occasion based on the first occasion at least partially overlapping with the second occasion or a time gap between the first occasion and the second occasion failing to satisfy a threshold time gap. The communications manager 820 is capable of, configured to, or operable to support a means for communicating, in accordance with the conflict resolution scheme, one of a signal with the EH-capable device during the second occasion or a report associated with the RRM operation.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced processing and more efficient utilization of communication resources.

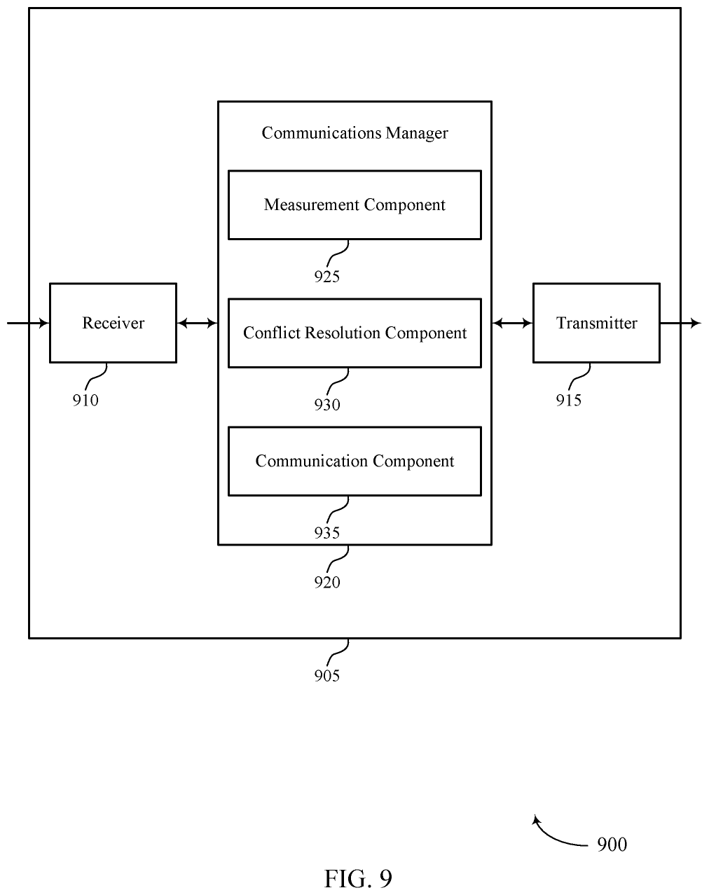

FIG. 9 shows a block diagram 900 of a device 905 that supports techniques for resolving scheduling conflicts between measurement occasions or reporting and communications with EH-capable devices in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for resolving scheduling conflicts between measurement occasions or reporting and communications with EH-capable devices). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for resolving scheduling conflicts between measurement occasions or reporting and communications with EH-capable devices). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for resolving scheduling conflicts between measurement occasions or reporting and communications with EH-capable devices as described herein. For example, the communications manager 920 may include a measurement component 925, a conflict resolution component 930, a communication component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a UE in accordance with examples as disclosed herein. The measurement component 925 is capable of, configured to, or operable to support a means for receiving, from a network entity, control signaling indicating that a first occasion is scheduled for an RRM operation and that a second occasion is scheduled for communication with an EH-capable device. The conflict resolution component 930 is capable of, configured to, or operable to support a means for identifying a conflict resolution scheme for resolving a scheduling conflict between the first occasion and the second occasion based on the first occasion at least partially overlapping with the second occasion or a time gap between the first occasion and the second occasion failing to satisfy a threshold time gap. The communication component 935 is capable of, configured to, or operable to support a means for communicating, in accordance with the conflict resolution scheme, one of a signal with the EH-capable device during the second occasion or a report associated with the RRM operation.

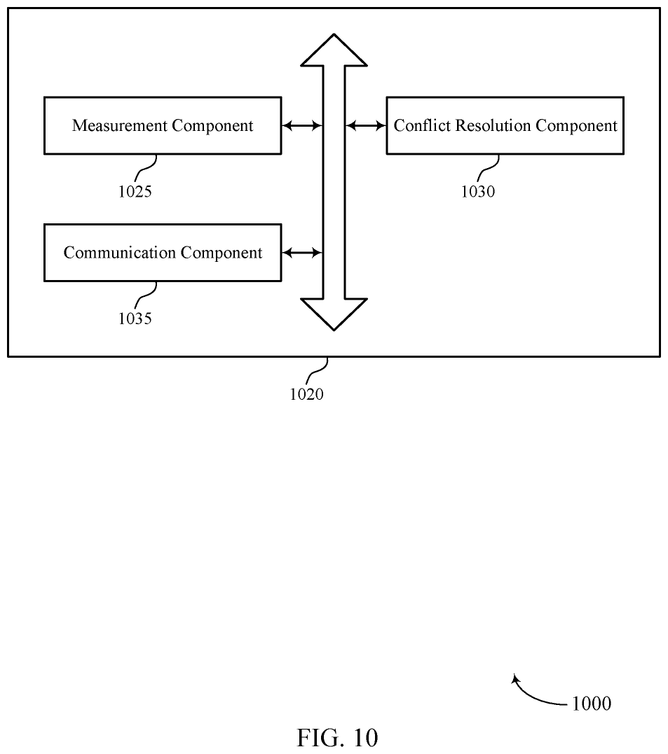

FIG. 10 shows a block diagram 1000 of a communications manager 1020 that supports techniques for resolving scheduling conflicts between measurement occasions or reporting and communications with EH-capable devices in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of techniques for resolving scheduling conflicts between measurement occasions or reporting and communications with EH-capable devices as described herein. For example, the communications manager 1020 may include a measurement component 1025, a conflict resolution component 1030, a communication component 1035, or any combination thereof. Each of these components may communicate, directly or indirectly, with one another (e.g., via one or more buses).

The communications manager 1020 may support wireless communications at a UE in accordance with examples as disclosed herein. The measurement component 1025 is capable of, configured to, or operable to support a means for receiving, from a network entity, control signaling indicating that a first occasion is scheduled for an RRM operation and that a second occasion is scheduled for communication with an EH-capable device. The conflict resolution component 1030 is capable of, configured to, or operable to support a means for identifying a conflict resolution scheme for resolving a scheduling conflict between the first occasion and the second occasion based on the first occasion at least partially overlapping with the second occasion or a time gap between the first occasion and the second occasion failing to satisfy a threshold time gap. The communication component 1035 is capable of, configured to, or operable to support a means for communicating, in accordance with the conflict resolution scheme, one of a signal with the EH-capable device during the second occasion or a report associated with the RRM operation.

In some examples, to support the communicating, the communication component 1035 is capable of, configured to, or operable to support a means for communicating, in accordance with the conflict resolution scheme, the signal based on a first priority associated with a communication session with the EH-capable device being higher than a second priority of the RRM operation.

In some examples, to support the communicating, the communication component 1035 is capable of, configured to, or operable to support a means for communicating, in accordance with the conflict resolution scheme, the signal based on a QoS associated with a communication session with the EH-capable device.

In some examples, to support the communicating, the communication component 1035 is capable of, configured to, or operable to support a means for communicating, in accordance with the conflict resolution scheme, the signal based on a remaining packet delay associated with a communication session with the EH-capable device.

In some examples, to support the communicating, the communication component 1035 is capable of, configured to, or operable to support a means for communicating, in accordance with the conflict resolution scheme, the signal based on a prior RRM measurement satisfying a threshold.

In some examples, to support the communicating, the communication component 1035 is capable of, configured to, or operable to support a means for communicating, in accordance with the conflict resolution scheme, the report based on a prior RRM measurement failing to satisfy a threshold.

In some examples, to support the communicating, the communication component 1035 is capable of, configured to, or operable to support a means for communicating, in accordance with the conflict resolution scheme, one of the report or the signal based on one or more previous conflict resolutions.

In some examples, to support identifying the conflict resolution scheme, the conflict resolution component 1030 is capable of, configured to, or operable to support a means for receiving, from the network entity, second control signaling indicating to communicate the report to the network entity or the signal with the EH-capable device during the second occasion, where one of the report or the signal is communicated in accordance with the second control signaling.

In some examples, to support the communicating, the communication component 1035 is capable of, configured to, or operable to support a means for communicating, in accordance with the conflict resolution scheme, the report based on one or more repetitions being scheduled for communicating the signal with the EH-capable device.

In some examples, to support the communicating, the communication component 1035 is capable of, configured to, or operable to support a means for communicating, in accordance with the conflict resolution scheme, the report based on a RLF for the UE or a cell change for the UE.

In some examples, the conflict resolution component 1030 is capable of, configured to, or operable to support a means for transmitting, to the network entity, second control signaling indicating the UE will not perform the RRM operation at the first occasion, where the signal is communicated based on the second control signaling.

In some examples, the conflict resolution component 1030 is capable of, configured to, or operable to support a means for transmitting, to a second UE and to the network entity, second control signaling indicating the UE will not perform the communication with the EH-capable device at the second occasion, where the report is communicated based on the second control signaling.

In some examples, to support the communicating, the communication component 1035 is capable of, configured to, or operable to support a means for communicating, in accordance with the conflict resolution scheme, the signal based on one or more repetitions being scheduled for the RRM operation.

In some examples, to support the communicating, the communication component 1035 is capable of, configured to, or operable to support a means for communicating, in accordance with the conflict resolution scheme, the report based on a first priority of the RRM operation being higher than a second priority of the communication with the EH-capable device.

In some examples, the threshold time gap is based on which of the first occasion and the second occasion occurs first.

In some examples, the report includes an RRM measurement performed during the first occasion or is communicated during the first occasion and includes an RRM measurement performed during a third occasion before the first occasion.

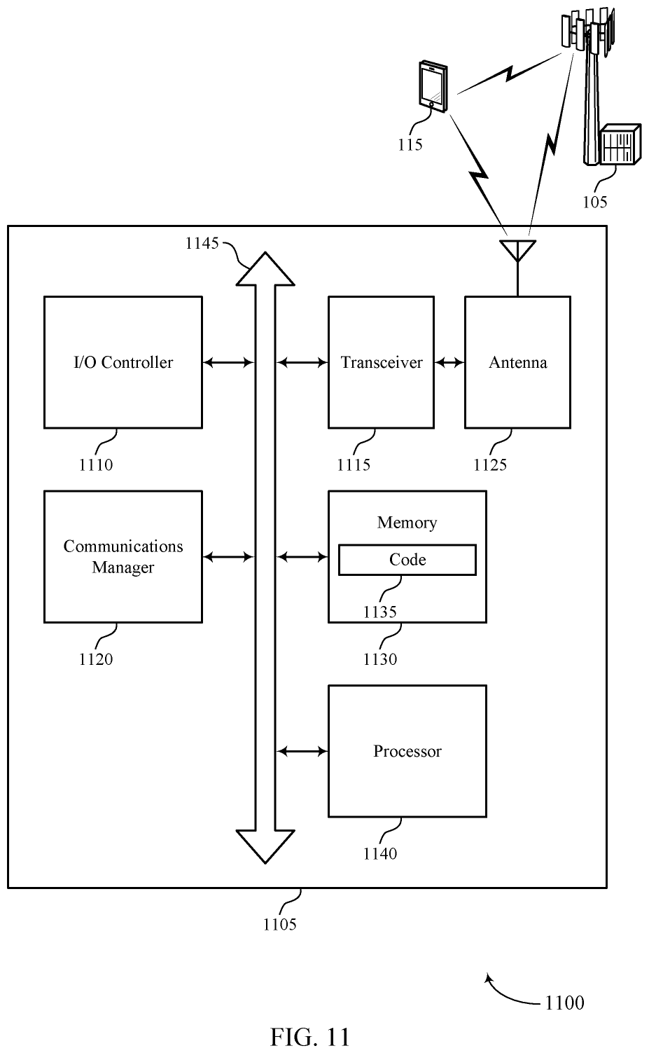

FIG. 11 shows a diagram of a system 1100 including a device 1105 that supports techniques for resolving scheduling conflicts between measurement occasions or reporting and communications with EH-capable devices in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for resolving scheduling conflicts between measurement occasions or reporting and communications with EH-capable devices). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communications at a UE in accordance with examples as disclosed herein. For example, the communications manager 1120 is capable of, configured to, or operable to support a means for receiving, from a network entity, control signaling indicating that a first occasion is scheduled for an RRM operation and that a second occasion is scheduled for communication with an EH-capable device. The communications manager 1120 is capable of, configured to, or operable to support a means for identifying a conflict resolution scheme for resolving a scheduling conflict between the first occasion and the second occasion based on the first occasion at least partially overlapping with the second occasion or a time gap between the first occasion and the second occasion failing to satisfy a threshold time gap. The communications manager 1120 is capable of, configured to, or operable to support a means for communicating, in accordance with the conflict resolution scheme, one of a signal with the EH-capable device during the second occasion or a report associated with the RRM operation.

By including or configuring the communications manager 1120 in accordance with examples as described herein, the device 1105 may support techniques for EH-based communication processing and RRM operation resolution, higher data rates, increased capacity, increased spectral efficiency, reduced latency, more efficient utilization of communication resources, and improved coordination between devices.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for resolving scheduling conflicts between measurement occasions or reporting and communications with EH-capable devices as described herein, or the processor 1140 and the memory 1130 may be otherwise configured to perform or support such operations.

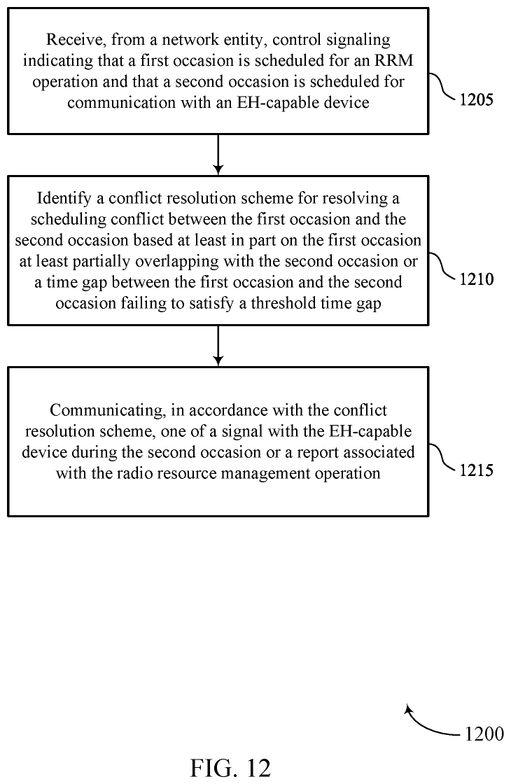

FIG. 12 shows a flowchart illustrating a method 1200 that supports techniques for resolving scheduling conflicts between measurement occasions or reporting and communications with EH-capable devices in accordance with aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1205, the method may include receiving, from a network entity, control signaling indicating that a first occasion is scheduled for an RRM operation and that a second occasion is scheduled for communication with an EH-capable device. The operations of 1205 may be performed in accordance with examples as disclosed herein. In some examples, aspects of the operations of 1205 may be performed by a measurement component 1025 as described with reference to FIG. 10.

At 1210, the method may include identifying a conflict resolution scheme for resolving a scheduling conflict between the first occasion and the second occasion based at least in part on the first occasion at least partially overlapping with the second occasion or a time gap between the first occasion and the second occasion failing to satisfy a threshold time gap. The operations of 1210 may be performed in accordance with examples as disclosed herein. In some examples, aspects of the operations of 1210 may be performed by a conflict resolution component 1030 as described with reference to FIG. 10.

At 1215, the method may include communicating, in accordance with the conflict resolution scheme, one of a signal with the EH-capable device during the second occasion or a report associated with the RRM operation. The operations of 1215 may be performed in accordance with examples as disclosed herein. In some examples, aspects of the operations of 1215 may be performed by a communication component 1035 as described with reference to FIG. 10.

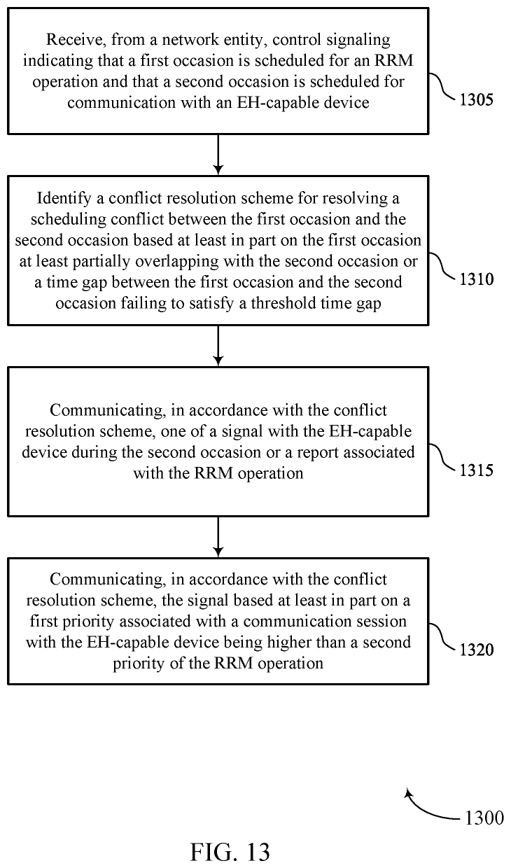

FIG. 13 shows a flowchart illustrating a method 1300 that supports techniques for resolving scheduling conflicts between measurement occasions or reporting and communications with EH-capable devices in accordance with aspects of the present disclosure. The operations of the method 1300 may be implemented by a UE or its components as described herein. For example, the operations of the method 1300 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1305, the method may include receiving, from a network entity, control signaling indicating that a first occasion is scheduled for an RRM operation and that a second occasion is scheduled for communication with an EH-capable device. The operations of 1305 may be performed in accordance with examples as disclosed herein. In some examples, aspects of the operations of 1305 may be performed by a measurement component 1025 as described with reference to FIG. 10.

At 1310, the method may include identifying a conflict resolution scheme for resolving a scheduling conflict between the first occasion and the second occasion based at least in part on the first occasion at least partially overlapping with the second occasion or a time gap between the first occasion and the second occasion failing to satisfy a threshold time gap. The operations of 1310 may be performed in accordance with examples as disclosed herein. In some examples, aspects of the operations of 1310 may be performed by a conflict resolution component 1030 as described with reference to FIG. 10.

At 1315, the method may include communicating, in accordance with the conflict resolution scheme, one of a signal with the EH-capable device during the second occasion or a report associated with the RRM operation. The operations of 1315 may be performed in accordance with examples as disclosed herein. In some examples, aspects of the operations of 1315 may be performed by a communication component 1035 as described with reference to FIG. 10.

At 1320, to support the communicating, the method may include communicating, in accordance with the conflict resolution scheme, the signal based at least in part on a first priority associated with a communication session with the EH-capable device being higher than a second priority of the RRM operation. The operations of 1320 may be performed in accordance with examples as disclosed herein. In some examples, aspects of the operations of 1320 may be performed by a communication component 1035 as described with reference to FIG. 10.

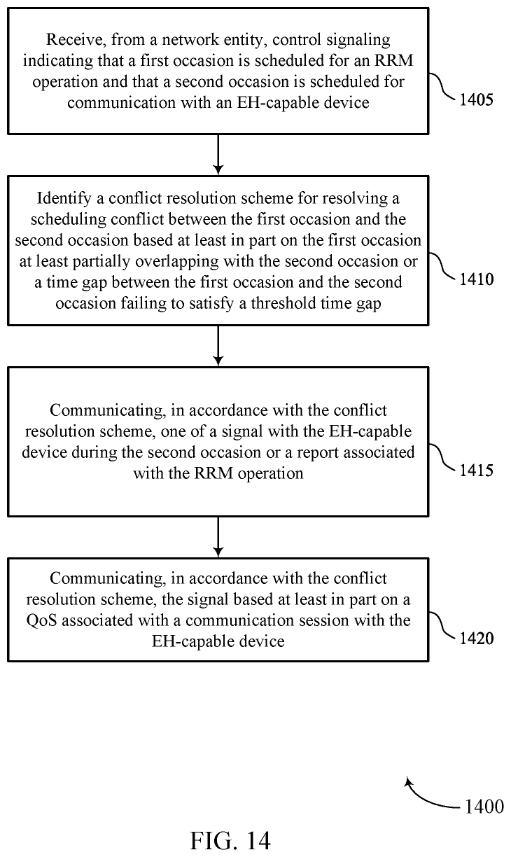

FIG. 14 shows a flowchart illustrating a method 1400 that supports techniques for resolving scheduling conflicts between measurement occasions or reporting and communications with EH-capable devices in accordance with aspects of the present disclosure. The operations of the method 1400 may be implemented by a UE or its components as described herein. For example, the operations of the method 1400 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1405, the method may include receiving, from a network entity, control signaling indicating that a first occasion is scheduled for an RRM operation and that a second occasion is scheduled for communication with an EH-capable device. The operations of 1405 may be performed in accordance with examples as disclosed herein. In some examples, aspects of the operations of 1405 may be performed by a measurement component 1025 as described with reference to FIG. 10.

At 1410, the method may include identifying a conflict resolution scheme for resolving a scheduling conflict between the first occasion and the second occasion based at least in part on the first occasion at least partially overlapping with the second occasion or a time gap between the first occasion and the second occasion failing to satisfy a threshold time gap. The operations of 1410 may be performed in accordance with examples as disclosed herein. In some examples, aspects of the operations of 1410 may be performed by a conflict resolution component 1030 as described with reference to FIG. 10.

At 1415, the method may include communicating, in accordance with the conflict resolution scheme, one of a signal with the EH-capable device during the second occasion or a report associated with the RRM operation. The operations of 1415 may be performed in accordance with examples as disclosed herein. In some examples, aspects of the operations of 1415 may be performed by a communication component 1035 as described with reference to FIG. 10.

At 1420, to support the communicating, the method may include communicating, in accordance with the conflict resolution scheme, the signal based at least in part on a QoS associated with a communication session with the EH-capable device. The operations of 1420 may be performed in accordance with examples as disclosed herein. In some examples, aspects of the operations of 1420 may be performed by a communication component 1035 as described with reference to FIG. 10.

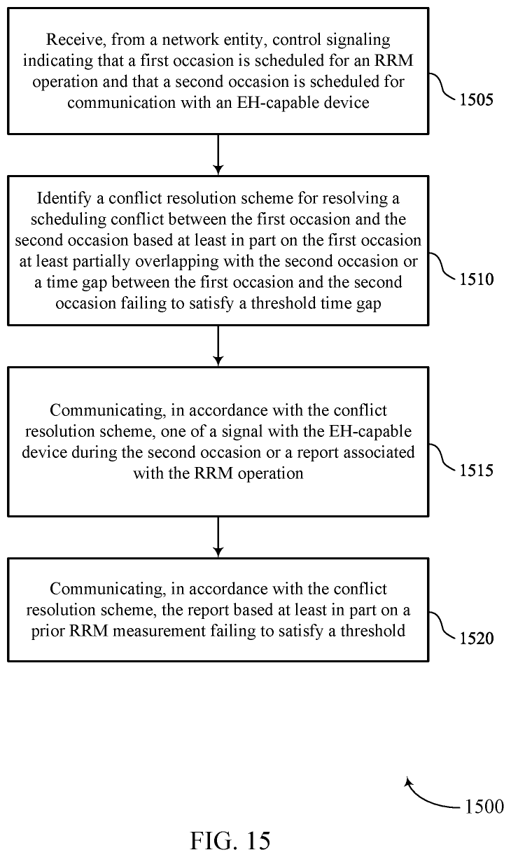

FIG. 15 shows a flowchart illustrating a method 1500 that supports techniques for resolving scheduling conflicts between measurement occasions or reporting and communications with EH-capable devices in accordance with aspects of the present disclosure. The operations of the method 1500 may be implemented by a UE or its components as described herein. For example, the operations of the method 1500 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1505, the method may include receiving, from a network entity, control signaling indicating that a first occasion is scheduled for an RRM operation and that a second occasion is scheduled for communication with an EH-capable device. The operations of 1505 may be performed in accordance with examples as disclosed herein. In some examples, aspects of the operations of 1505 may be performed by a measurement component 1025 as described with reference to FIG. 10.

At 1510, the method may include identifying a conflict resolution scheme for resolving a scheduling conflict between the first occasion and the second occasion based at least in part on the first occasion at least partially overlapping with the second occasion or a time gap between the first occasion and the second occasion failing to satisfy a threshold time gap. The operations of 1510 may be performed in accordance with examples as disclosed herein. In some examples, aspects of the operations of 1510 may be performed by a conflict resolution component 1030 as described with reference to FIG. 10.

At 1515, the method may include communicating, in accordance with the conflict resolution scheme, one of a signal with the EH-capable device during the second occasion or a report associated with the RRM operation. The operations of 1515 may be performed in accordance with examples as disclosed herein. In some examples, aspects of the operations of 1515 may be performed by a communication component 1035 as described with reference to FIG. 10.

At 1520, to support the communicating, the method may include communicating, in accordance with the conflict resolution scheme, the report based at least in part on a prior RRM measurement failing to satisfy a threshold. The operations of 1520 may be performed in accordance with examples as disclosed herein. In some examples, aspects of the operations of 1520 may be performed by a communication component 1035 as described with reference to FIG. 10.

The following provides an overview of aspects of the present disclosure:
Aspect 1: A method for wireless communications at a UE, comprising: receiving, from a network entity, control signaling indicating that a first occasion is scheduled for an RRM operation and that a second occasion is scheduled for communication with an EH-capable device; identifying a conflict resolution scheme for resolving a scheduling conflict between the first occasion and the second occasion based at least in part on the first occasion at least partially overlapping with the second occasion or a time gap between the first occasion and the second occasion failing to satisfy a threshold time gap; and communicating, in accordance with the conflict resolution scheme, one of a report comprising an RRM measurement performed during the first occasion to the network entity, the report to the network entity during the first occasion, or a signal with the EH-capable device during the second occasion.
Aspect 2: The method of aspect 1, wherein the communicating further comprises: communicating, in accordance with the conflict resolution scheme, the signal based at least in part on a first priority associated with a communication session with the EH-capable device being higher than a second priority of the RRM operation.
Aspect 3: The method of any of aspects 1 through 2, wherein the communicating further comprises: communicating, in accordance with the conflict resolution scheme, the signal based at least in part on a quality of service associated with a communication session with the EH-capable device.
Aspect 4: The method of any of aspects 1 through 3, wherein the communicating further comprises: communicating, in accordance with the conflict resolution scheme, the signal based at least in part on a remaining packet delay associated with a communication session with the EH-capable device.
Aspect 5: The method of any of aspects 1 through 4, wherein the communicating further comprises: communicating, in accordance with the conflict resolution scheme, the signal based at least in part on a prior RRM operation satisfying a threshold.
Aspect 6: The method of aspect 1, wherein the communicating further comprises: communicating, in accordance with the conflict resolution scheme, the report based at least in part on a prior RRM operation failing to satisfy a threshold.
Aspect 7: The method of any of aspects 1 through 6, wherein the communicating further comprises: communicating, in accordance with the conflict resolution scheme, one of the report or the signal based at least in part on one or more previous conflict resolutions.
Aspect 8: The method of any of aspects 1 through 7, wherein identifying the conflict resolution scheme further comprises: receiving, from the network entity, second control signaling indicating to communicate the report to the network entity or the signal with the EH-capable device during the second occasion, wherein one of the report or the signal is communicated in accordance with the second control signaling.
Aspect 9: The method of any of aspects 1 and 6 through 8, wherein the communicating further comprises: communicating, in accordance with the conflict resolution scheme, the report based at least in part on one or more repetitions being scheduled for communicating the signal with the EH-capable device.
Aspect 10: The method of any of aspects 1 and 6 through 9, wherein the communicating further comprises: communicating, in accordance with the conflict resolution scheme, the report based at least in part on a radio link failure for the UE or a cell change for the UE.
Aspect 11: The method of any of aspects 1 through 5 and 7 through 8, further comprising: transmitting, to the network entity, second control signaling indicating the UE will not perform the RRM operation at the first occasion, wherein the signal is communicated based at least in part on the second control signaling.
Aspect 12: The method of any of aspects 1 and 6 through 10, further comprising: transmitting, to a second UE and to the network entity, second control signaling indicating the UE will not perform the communication with the EH-capable device at the second occasion, wherein the report is communicated based at least in part on the second control signaling.
Aspect 13: The method of any of aspects 1 through 5, 7 through 8, and 11, wherein the communicating further comprises: communicating, in accordance with the conflict resolution scheme, the signal based at least in part on one or more repetitions being scheduled for the RRM operation.
Aspect 14: The method of any of aspects 1, 6 through 10, and 12, wherein the communicating further comprises: communicating, in accordance with the conflict resolution scheme, the report based at least in part on a first priority of the RRM operation being higher than a second priority of the communication with the EH-capable device.
Aspect 15: The method of any of aspects 1 through 14, wherein the threshold time gap is based at least in part on which of the first occasion and the second occasion occurs first.
Aspect 16: The method of any of aspects 1, 6 through 10, 12, and 14, wherein the report comprises an RRM measurement performed during the first occasion or is communicated during the first occasion and comprises an RRM measurement performed during a third occasion before the first occasion.
Aspect 17: An apparatus for wireless communications at a UE, comprising at least one processor; and memory coupled (e.g., operatively, communicatively, functionally, electronically, or electrically) with the at least one processor, the memory storing instructions executable by the at least one processor (e.g., directly, indirectly, after pre-processing, without pre-processing) to cause the apparatus to perform a method of any of aspects 1 through 16.
Aspect 18: An apparatus for wireless communications at a UE, comprising at least one means for performing a method of any of aspects 1 through 16.
Aspect 19: A non-transitory computer-readable medium storing code for wireless communications at a UE, the code comprising instructions executable by at least one processor (e.g., directly, indirectly, after pre-processing, without pre-processing) to perform a method of any of aspects 1 through 16.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc. as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., including a list of items prefaced by a phrase such as “at least one of” or “one or more of”) indicates an inclusive list such that, for example, a list of at least one of A, B, or C. e.g., means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
at least one processor; and
memory coupled with the at least one processor, the memory storing instructions executable by the at least one processor to cause the UE to:
receive, from a network entity, control signaling indicating that a first occasion is scheduled for a radio resource management operation and that a second occasion is scheduled for communication with an energy harvesting (EH)-capable device;
identify a conflict resolution scheme for resolving a scheduling conflict between the first occasion and the second occasion based at least in part on the first occasion at least partially overlapping with the second occasion or a time gap between the first occasion and the second occasion failing to satisfy a threshold time gap; and
communicate, in accordance with the conflict resolution scheme, one of a signal with the EH-capable device during the second occasion or a report associated with the radio resource management operation.

2. The apparatus of claim 1, wherein the instructions to communicate are further executable by the at least one processor to cause the UE to:
communicate, in accordance with the conflict resolution scheme, the signal based at least in part on a first priority associated with a communication session with the EH-capable device being higher than a second priority of the radio resource management operation.

3. The apparatus of claim 1, wherein the instructions to communicate are further executable by the at least one processor to cause the UE to:
communicate, in accordance with the conflict resolution scheme, the signal based at least in part on a quality of service associated with a communication session with the EH-capable device.

4. The apparatus of claim 1, wherein the instructions to communicate are further executable by the at least one processor to cause the UE to:
communicate, in accordance with the conflict resolution scheme, the signal based at least in part on a remaining packet delay associated with a communication session with the EH-capable device.

5. The apparatus of claim 1, wherein the instructions to communicate are further executable by the at least one processor to cause the UE to:
communicate, in accordance with the conflict resolution scheme, the signal based at least in part on a prior radio resource management measurement satisfying a threshold.

6. The apparatus of claim 1, wherein the instructions to communicate are further executable by the at least one processor to cause the UE to:
communicate, in accordance with the conflict resolution scheme, the report based at least in part on a prior radio resource management measurement failing to satisfy a threshold.

7. The apparatus of claim 1, wherein the instructions to communicate are further executable by the at least one processor to cause the UE to:
communicate, in accordance with the conflict resolution scheme, one of the report or the signal based at least in part on one or more previous conflict resolutions.

8. The apparatus of claim 1, wherein the instructions to identify the conflict resolution scheme are further executable by the at least one processor to cause the UE to:
receive, from the network entity, second control signaling indicating to communicate the report to the network entity or the signal with the EH-capable device during the second occasion, wherein one of the report or the signal is communicated in accordance with the second control signaling.

9. The apparatus of claim 1, wherein the instructions to communicate are further executable by the at least one processor to cause the UE to:
communicate, in accordance with the conflict resolution scheme, the report based at least in part on one or more repetitions being scheduled for communicating the signal with the EH-capable device.

10. The apparatus of claim 1, wherein the instructions to communicate are further executable by the at least one processor to cause the UE to:
communicate, in accordance with the conflict resolution scheme, the report based at least in part on a radio link failure for the UE or a cell change for the UE.

11. The apparatus of claim 1, wherein the instructions are further executable by the at least one processor to cause the UE to:
transmit, to the network entity, second control signaling indicating the UE will not perform the radio resource management operation at the first occasion, wherein the signal is communicated based at least in part on the second control signaling.

12. The apparatus of claim 1, wherein the instructions are further executable by the at least one processor to cause the UE to:
transmit, to a second UE and to the network entity, second control signaling indicating the UE will not perform the communication with the EH-capable device at the second occasion, wherein the report is communicated based at least in part on the second control signaling.

13. The apparatus of claim 1, wherein the instructions to communicate are further executable by the at least one processor to cause the UE to:
communicate, in accordance with the conflict resolution scheme, the signal based at least in part on one or more repetitions being scheduled for the radio resource management operation.

14. The apparatus of claim 1, wherein the instructions to communicate are further executable by the at least one processor to cause the UE to:
communicate, in accordance with the conflict resolution scheme, the report based at least in part on a first priority of the radio resource management operation being higher than a second priority of the communication with the EH-capable device.

15. The apparatus of claim 1, wherein the threshold time gap is based at least in part on which of the first occasion and the second occasion occurs first.

16. The apparatus of claim 1, wherein the report comprises a radio resource management measurement performed during the first occasion or is communicated during the first occasion and comprises a radio resource management measurement performed during a third occasion before the first occasion.

17. A method for wireless communications at a user equipment (UE), comprising:
receiving, from a network entity, control signaling indicating that a first occasion is scheduled for a radio resource management operation and that a second occasion is scheduled for communication with an energy harvesting (EH)-capable device;
identifying a conflict resolution scheme for resolving a scheduling conflict between the first occasion and the second occasion based at least in part on the first occasion at least partially overlapping with the second occasion or a time gap between the first occasion and the second occasion failing to satisfy a threshold time gap; and
communicating, in accordance with the conflict resolution scheme, one of a signal with the EH-capable device during the second occasion or a report associated with the radio resource management operation.

18. The method of claim 17, wherein the communicating further comprises:
communicating, in accordance with the conflict resolution scheme, the signal based at least in part on a first priority associated with a communication session with the EH-capable device being higher than a second priority of the radio resource management operation.

19. The method of claim 17, wherein the communicating further comprises:
communicating, in accordance with the conflict resolution scheme, the signal based at least in part on a quality of service associated with a communication session with the EH-capable device.

20. The method of claim 17, wherein the communicating further comprises:
communicating, in accordance with the conflict resolution scheme, the signal based at least in part on a remaining packet delay associated with a communication session with the EH-capable device.

21. The method of claim 17, wherein the communicating further comprises:
communicating, in accordance with the conflict resolution scheme, the signal based at least in part on a prior radio resource management measurement satisfying a threshold.

22. The method of claim 17, wherein the communicating further comprises:
communicating, in accordance with the conflict resolution scheme, the report based at least in part on a prior radio resource management measurement failing to satisfy a threshold.

23. The method of claim 17, wherein the communicating further comprises:
communicating, in accordance with the conflict resolution scheme, one of the report or the signal based at least in part on one or more previous conflict resolutions.

24. The method of claim 17, wherein identifying the conflict resolution scheme further comprises:
receiving, from the network entity, second control signaling indicating to communicate the report to the network entity or the signal with the EH-capable device during the second occasion, wherein one of the report or the signal is communicated in accordance with the second control signaling.

25. The method of claim 17, wherein the communicating further comprises:
communicating, in accordance with the conflict resolution scheme, the report based at least in part on one or more repetitions being scheduled for communicating the signal with the EH-capable device.

26. The method of claim 17, wherein the communicating further comprises:
communicating, in accordance with the conflict resolution scheme, the report based at least in part on a radio link failure for the UE or a cell change for the UE.

27. The method of claim 17, further comprising:
transmitting, to the network entity, second control signaling indicating that the UE will not perform the radio resource management operation at the first occasion or that the UE will not perform the communication with the EH-capable device, wherein the signal or the report is communicated based at least in part on the second control signaling.

28. The method of claim 17, wherein the communicating further comprises:
communicating, in accordance with the conflict resolution scheme, the signal based at least in part on one or more repetitions being scheduled for the radio resource management operation.

29. An apparatus for wireless communications at a user equipment (UE), comprising:
means for receiving, from a network entity, control signaling indicating that a first occasion is scheduled for a radio resource management operation and that a second occasion is scheduled for communication with an energy harvesting (EH)-capable device;
means for identifying a conflict resolution scheme for resolving a scheduling conflict between the first occasion and the second occasion based at least in part on the first occasion at least partially overlapping with the second occasion or a time gap between the first occasion and the second occasion failing to satisfy a threshold time gap; and
means for communicating, in accordance with the conflict resolution scheme, one of a signal with the EH-capable device during the second occasion or a report associated with the radio resource management operation.

30. A non-transitory computer-readable medium storing code for wireless communication at a user equipment (UE), the code comprising instructions executable by at least one processor to:
receive, from a network entity, control signaling indicating that a first occasion is scheduled for a radio resource management operation and that a second occasion is scheduled for communication with an energy harvesting (EH)-capable device;
identify a conflict resolution scheme for resolving a scheduling conflict between the first occasion and the second occasion based at least in part on the first occasion at least partially overlapping with the second occasion or a time gap between the first occasion and the second occasion failing to satisfy a threshold time gap; and
communicate, in accordance with the conflict resolution scheme, one of a signal with the EH-capable device during the second occasion or a report associated with the radio resource management operation.
